(19) United States
(12) Patent Application Publication
(10) Pub. No.: US 2025/0192847 A1
(43) Pub. Date: Jun. 12, 2025

(54) CHANNEL STATE INFORMATION (CSI) INCLUDING A PRECODING MATRIX INDICATOR (PMI)

(71) Applicant: Lenovo (Singapore) Pte. Limited, Singapore (SG)

(72) Inventors: Mahdi Barzegar Khalilsarai, Berlin (DE); Ahmed Hindy, Aurora, IL (US)

(73) Assignee: Lenovo (Singapore) Pte. Limited, Singapore (SG)

(21) Appl. No.: 18/970,105

(22) Filed: Dec. 5, 2024

Related U.S. Application Data
(60) Provisional application No. 63/607,401, filed on Dec. 7, 2023.

(51) Int. Cl. H04B 7/06

(52) U.S. Cl. CPC H04B 7/0626; H04B 7/0617; H04B 7/0632; H04B 7/0639

(57) ABSTRACT

Various aspects relate to channel state information (CSI) including a precoding matrix indicator (PMI). An apparatus (e.g., user equipment (UE)) generates a CSI report including a PMI for a precoding matrix and a channel quality indicator (CQI). The precoding matrix corresponds to layers with each layer associated with a spatial beam and a size of the set of layers determined by a rank indicator (RI). The precoding matrix is associated with a subset of CSI reference signal (RS)(CSI-RS) ports, and the PMI and the CQI are each associated with at least one of a wideband format or a subband format, with the subband format corresponding to reporting at least one of the PMI or the CQI for a subset of subbands of a bandwidth part associated with a CSI reporting setting. The apparatus transmits the CSI report including the RI, the PMI, and the CQI to a network entity.

### RELATED APPLICATIONS

This application claims priority to U.S. Provisional Application Ser. No. 63/607,401 filed Dec. 7, 2023 entitled “CSI ENHANCEMENTS,” the disclosure of which is incorporated by reference herein in its entirety.

### TECHNICAL FIELD

The present disclosure relates to wireless communications, and more specifically to channel state information (CSI) reporting.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to generate a CSI report including a precoding matrix indicator (PMI) for at least one precoding matrix and a channel quality indicator (CQI) for channel quality: the at least one precoding matrix corresponding to a set of layers with each layer of the set of layers associated with a spatial beam and a size of the set of layers determined by a rank indicator (RI) reported by the UE; the at least one precoding matrix being associated with a subset of CSI reference signal (RS)(CSI-RS) ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmit the CSI report including the RI, the PMI, and the CQI to a network entity (NE).

In some implementations of the method and apparatuses described herein the UE is configured to receive, from the network entity, a configuration signal corresponding to the CSI reporting setting; receive CSI-RS corresponding to at least one non-zero power (NZP) CSI-RS resource including the plurality of CSI-RS ports and based at least in part on the CSI reporting setting; and generate the CSI report based at least in part on the CSI reporting setting and the CSI-RS; report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI.

Some implementations of the method and apparatuses described herein further include where a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Some implementations of the method and apparatuses described herein further include a method performed by a UE including generating a CSI report including a PMI for at least one precoding matrix and a CQI for channel quality: the at least one precoding matrix corresponding to a set of layers with each layer of the set of layers associated with a spatial beam and a size of the set of layers determined by a RI reported by the UE; the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmitting the CSI report including the RI, the PMI, and the CQI to a network entity.

In some implementations of the method and apparatuses described herein the method further includes receiving, from the network entity, a configuration signal corresponding to the CSI reporting setting; receiving CSI-RS corresponding to at least one NZP CSI-RS resource including the plurality of CSI-RS ports and based at least in part on the CSI reporting setting; and generating the CSI report based at least in part on the CSI reporting setting and the CSI-RS; reporting a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports.

In some implementations of the method and apparatuses described herein the method further includes where at least two different layer groups are associated with mutually exclusive subsets of the plurality of CSI-RS ports; a number of groups of the multiple layer groups is based on a value of the RI; a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Some implementations of the method and apparatuses described herein may further include a processor for wireless communication to generate a CSI report including a PMI for at least one precoding matrix and a CQI for channel quality: the at least one precoding matrix corresponding to a set of layers with each layer of the set of layers associated with a spatial beam and a size of the set of layers determined by a RI reported by a user equipment (UE); the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmit the CSI report including the RI, the PMI, and the CQI to a network entity.

In some implementations of the method and apparatuses described herein the processor is configured to receive, from the network entity, a configuration signal corresponding to the CSI reporting setting; receive CSI-RS corresponding to at least one NZP CSI-RS resource including the plurality of CSI-RS ports and based at least in part on the CSI reporting setting; and generate the CSI report based at least in part on the CSI reporting setting and the CSI-RS; report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports.

In some implementations of the method and apparatuses described herein at least two different layer groups are associated with mutually exclusive subsets of the plurality of CSI-RS ports; a number of groups of the multiple layer groups is based on a value of the RI; a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands

Some implementations of the method and apparatuses described herein may further include an NE to transmit, to a user equipment (UE), a configuration signal corresponding to a CSI reporting setting, the CSI reporting setting including: an indication to generate a CSI report for at least a subset of CSI-RS ports of a plurality of CSI-RS ports including a PMI for at least one precoding matrix and a CQI for channel quality; the at least one precoding matrix corresponding to a set of layers with each layer of the set of layers associated with a spatial beam and a size of the set of layers determined by a RI reported by the UE; and the PMI and the CQI each being associated with at least one of a wideband format or a subband format, and the subband format corresponding to reporting at least one of the PMI or the CQI for a subset of a set of subbands of a bandwidth part associated with the CSI reporting setting; and receive, from the UE, a CSI report including the RI, the PMI, and the CQI.

In some implementations of the method and apparatuses described herein, the NE is configured to transmit CSI-RS corresponding to at least one NZP CSI-RS resource including the plurality of CSI-RS ports; receive, from the UE, a report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI; a number of groups of the multiple layer groups is no less than half of the value of the RI.

In some implementations of the method and apparatuses described herein, the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Some implementations of the method and apparatuses described herein may further include a method performed by an NE, the method including transmitting, to a user equipment (UE), a configuration signal corresponding to a CSI reporting setting, the CSI reporting setting including: an indication to generate a CSI report for at least a subset of CSI-RS ports of a plurality of CSI-RS ports including a PMI for at least one precoding matrix and a CQI for channel quality; the at least one precoding matrix corresponding to a set of layers with each layer of the set of layers associated with a spatial beam and a size of the set of layers determined by a RI reported by the UE; and the PMI and the CQI each being associated with at least one of a wideband format or a subband format, and the subband format corresponding to reporting at least one of the PMI or the CQI for a subset of a set of subbands of a bandwidth part associated with the CSI reporting setting; and receiving, from the UE, a CSI report including the RI, the PMI, and the CQI.

In some implementations of the method and apparatuses described herein the method performed by the NE further includes transmitting CSI-RS corresponding to at least one NZP CSI-RS resource including the plurality of CSI-RS ports; receiving, from the UE, a report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI; a number of groups of the multiple layer groups is no less than half of the value of the RI; the CQI is associated with the subband format according to a subband configuration; CQI values associated with only even subbands are included in the CSI report; a value of the RI is larger than four.

In some implementations of the method and apparatuses described herein the method performed by the NE further includes where the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Some implementations of the method and apparatuses described herein may further include a UE for wireless communication to generate a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmit the CSI report to a network entity.

In some implementations of the method and apparatuses described herein the UE is configured to receive, from the network entity, a configuration signal corresponding to a CSI reporting setting; receive CSI-RSs corresponding to at least one NZP CSI-RS resource including the plurality of CSI-RS ports based at least in part on the CSI reporting setting; and generate the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation.

In some implementations of the method and apparatuses described herein the plurality of CSI-RS ports are associated with at least two spatial dimensions, and where dimensions of the first transform domain correspond to at least two spatial sub-dimensions associated with the at least two spatial dimensions; a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

In some implementations of the method and apparatuses described herein the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

Some implementations of the method and apparatuses described herein may further include a method performed by a UE, the method including generating a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmitting the CSI report to a network entity.

In some implementations of the method and apparatuses described herein, the method performed by the UE further includes receiving, from the network entity, a configuration signal corresponding to a CSI reporting setting; receiving CSI-RSs corresponding to at least one NZP CSI-RS resource including the plurality of CSI-RS ports based at least in part on the CSI reporting setting; and generating the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation.

In some implementations of the method and apparatuses described herein, the plurality of CSI-RS ports are associated with at least two spatial dimensions, and where dimensions of the first transform domain correspond to at least two spatial sub-dimensions associated with the at least two spatial dimensions; a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

In some implementations of the method and apparatuses described herein, the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

Some implementations of the method and apparatuses described herein may further include a processor for wireless communication to generate a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmit the CSI report to a network entity.

In some implementations of the method and apparatuses described herein the processor is configured to receive, from the network entity, a configuration signal corresponding to a CSI reporting setting; receive CSI-RSs corresponding to at least one NZP CSI-RS resource including the plurality of CSI-RS ports based at least in part on the CSI reporting setting; and generate the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

In some implementations of the method and apparatuses described herein a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

In some implementations of the method and apparatuses described herein the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

Some implementations of the method and apparatuses described herein may further include an NE for wireless communication to transmit, to a user equipment (UE), a configuration signal corresponding to a CSI reporting setting, the CSI reporting setting including at least one codebook mode and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain.

In some implementations of the method and apparatuses described herein the NE is configured to transmit, to the UE, CSI-RSs corresponding to at least one NZP CSI-RS resource including the plurality of CSI-RS ports based at least in part on the CSI reporting setting; and receive, from the UE, a CSI report based at least in part on the CSI reporting setting; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

In some implementations of the method and apparatuses described herein a size of a first spatial dimension of the at least two spatial dimensions is equal to an integer multiple of a size of a first spatial sub-dimension of the two spatial sub-dimensions, and a size of a second spatial dimension of the at least two spatial dimensions is equal to an integer multiple of a size of a second spatial sub-dimension of the at least two spatial sub-dimensions; configure the size of the first spatial sub-dimension and the size of the second spatial sub-dimension; receive, from the UE, a CSI report based at least in part on the CSI reporting setting, and coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

In some implementations of the method and apparatuses described herein the second transformation is based at least in part on one or more of Rel-15 Type-I Single Panel codebook, Rel-16 eType-II codebook, Rel-17 FeType-II codebook, or Rel-18 Type-II Doppler codebook; receive, from the UE, a CSI report including an indication of a precoding matrix, and where the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; configure the UE with a selection of at least one codebook mode of the at least two codebook modes.

Some implementations of the method and apparatuses described herein may further include a method performed by an NE the method including transmitting, to a user equipment (UE), a configuration signal corresponding to a CSI reporting setting, the CSI reporting setting including at least one codebook mode and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain.

In some implementations of the method and apparatuses described herein the method performed by the NE further includes transmitting, to the UE, CSI-RSs corresponding to at least one NZP CSI-RS resource including the plurality of CSI-RS ports based at least in part on the CSI reporting setting; and receiving, from the UE, a CSI report based at least in part on the CSI reporting setting; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

In some implementations of the method and apparatuses described herein a size of a first spatial dimension of the at least two spatial dimensions is equal to an integer multiple of a size of a first spatial sub-dimension of the two spatial sub-dimensions, and a size of a second spatial dimension of the at least two spatial dimensions is equal to an integer multiple of a size of a second spatial sub-dimension of the at least two spatial sub-dimensions; configuring the size of the first spatial sub-dimension and the size of the second spatial sub-dimension; receiving, from the UE, a CSI report based at least in part on the CSI reporting setting, and coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

In some implementations of the method and apparatuses described herein the second transformation is based at least in part on one or more of Rel-15 Type-I Single Panel codebook, Rel-16 eType-II codebook, Rel-17 FeType-II codebook, or Rel-18 Type-II Doppler codebook; receiving, from the UE, a CSI report including an indication of a precoding matrix, and where the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; configuring the UE with a selection of at least one codebook mode of the at least two codebook modes.

### BRIEF DESCRIPTION OF THE DRAWINGS

FIG. 1 illustrates an example of a wireless communications system in accordance with aspects of the present disclosure.

FIG. 2 illustrates aperiodic trigger state defining a list of CSI report settings.

FIG. 3 illustrates at aperiodic trigger state indicating the resource set and QCL information.

FIGS. 4 and 5 illustrate RRC configuration for NZP-CSI-RS/CSI-IM resources.

FIG. 6 illustrates at partial CSI omission for Rel. 15 PUSCH-Based CSI.

FIGS. 7 and 8 illustrate different respective portions an example IE in accordance with aspects of the present disclosure.

FIG. 9 illustrates an example IE in accordance with aspects of the present disclosure.

FIG. 10 illustrates an implementation in accordance with aspects of the present disclosure.

FIG. 11 illustrates an implementation in accordance with aspects of the present disclosure.

FIG. 12 illustrates an implementation in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of a NE in accordance with aspects of the present disclosure.

FIG. 16 illustrates a flowchart of a method in accordance with aspects of the present disclosure.

FIG. 17 illustrates a flowchart of a method in accordance with aspects of the present disclosure.

FIG. 18 illustrates a flowchart of a method in accordance with aspects of the present disclosure.

FIG. 19 illustrates a flowchart of a method in accordance with aspects of the present disclosure.

### DETAILED DESCRIPTION

In 5G New Radio (NR), CSI feedback is reported by a UE to the network in various possible forms based on CSI format, frequency granularity (e.g., wideband vs sub-band reporting), and temporal periodic/non-periodic reporting. The PMI is a field in the CSI report and includes parameters that point to a particular member of a pre-specified CSI codebook. The 5G NR CSI codebooks have evolved since Rel. 15 to evermore enhance spatial resolution, support multi-user Multiple-Input-Multiple-Output (MIMO) systems, and reduce CSI feedback overhead. While these codebooks support up to 32 CSI-RS ports, the advancements in implementation and the utilization of higher frequency bands has enabled larger antenna arrays to be deployed in the network. Thus, some CSI frameworks may experience difficulties and inefficiencies in accommodating larger antenna arrays, such as increased CSI complexity resulting in increased overhead.

Accordingly, the present disclosure provides techniques for the construction of precoding matrices to be used at the network side for large number of CSI-RS ports. For instance, an enhanced CSI framework for Type-I codebook is provided that supports a flexible design corresponding to beam association with layers, in addition to port association with layers. Further, an updated PMI/CQI reporting format for Type-I codebook is provided that allows reporting a subset of the PMI/CQI values per sub-band (e.g., reporting for alternating sub-bands only) to reduce the overall CSI feedback overhead and exploit the additional degrees of freedom associated with a large number of CSI-RS ports.

The described techniques further provide an enhanced CSI framework that supports a two-stage precoding matrix codebook design where a first of the two stages is tasked to transform the channel coefficients over a large number (e.g., greater than 32) of CSI-RS ports to a smaller dimension, and a second of the two stages includes a precoding matrix that belongs to a legacy codebook. Further, a dual mode codebook design is provided that supports two codebook modes, such as where a first codebook mode is an extension of the legacy codebook types (e.g., Rel-15 Type-I Single Panel codebook, Rel-16 eType-II codebook, Rel-17 FeType-II codebook, or Rel-18 Type-II Doppler codebook) and a second codebook mode which includes the two-stage codebook design mentioned above.

Thus the described solutions provide a number of benefits including complexity reduction, overhead reduction, and strong compliance with existing CSI frameworks. For instance, in considering complexity reduction, a UE can avoid the computational complexity induced by an extension of the legacy codebooks to a large number of CSI-RS ports. Selecting the PMI at the UE side often involves computing singular value decompositions (SVDs) of the inferred channel at the UE side. With a large number of ports (e.g., greater than 32), computing SVDs and similar matrix operations can be costly both in time and power. With the proposed solutions this surplus of complexity can be avoided by carefully reducing the dimension of the CSI via port subset selection for different layers of the precoding matrix.

In terms of overhead reduction, reporting a subset of the PMI/CQI corresponding to a subset of the sub-bands as described herein results in a considerable reduction of the feedback size, which can make up for the additional CSI feedback overhead incurred by the significantly large number of CSI-RS ports, e.g., greater than 32 ports. In terms of compliance with existing CSI frameworks, the proposed solutions provide effective incremental upgrades to the legacy codebook design without requiring new designs or modifications.

Aspects of the present disclosure are described in the context of a wireless communications system.

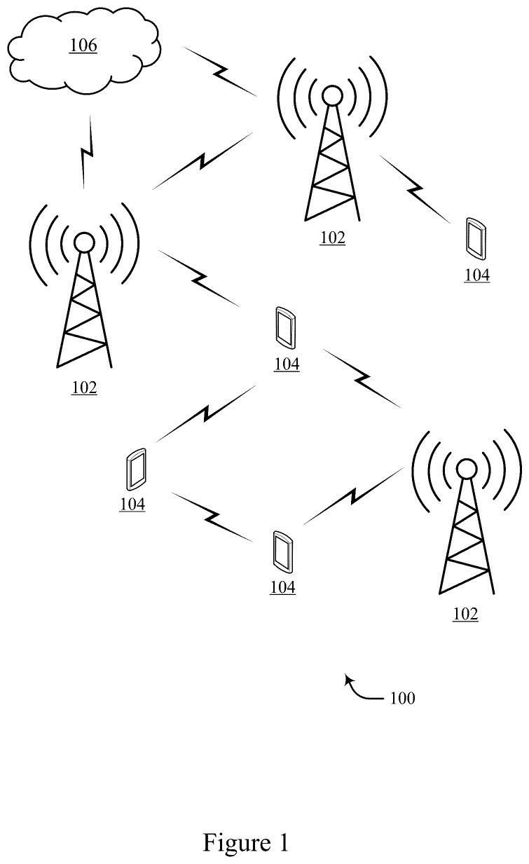

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. Reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) communicates a configuration signal to a UE 104 including one or more CSI reporting settings, examples of which are described throughout this disclosure. The UE 104 receives the CSI reporting settings along with CSI-RS and generates a CSI report based at least in part on the CSI reporting settings and the CSI-RS. The CSI report includes information such as RI, PMI, and CQI determined from the CSI-RS and based at least in part on the CSI reporting settings. The UE 104 transmits the CSI report to the NE 102 and the NE 102 can utilize information from the CSI report for various purposes, such as optimizing wireless communication between the NE 102 and the UE 104.

The following provides a summary of NR codebook types and additional details can be found in 3GPP Technical Specification (TS) 38.214, “Physical layer procedures for data,” December 2022, hereinafter referenced as [1]. For NR Rel. 15 Type-II codebook, assume the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band includes a set of resource blocks (RBs), each RB including a set of subcarriers. Considering dual-polarization, there are 2N₁N₂ CSI-RS ports are utilized to enable downlink (DL) channel estimation with high resolution for NR Rel. 15 Type-II codebook. In order to reduce feedback overhead in Uplink (UL), a Discrete Fourier transform (DFT)-based transformation is used to project the channel onto L spatial beams (shared by both polarizations) where L<N₁N₂. In the sequel the indices of the L beams are referred as the Spatial Domain (SD) basis indices. The magnitude and phase values of the 2L linear combination coefficients for each sub-band are fed back to the gNB as part of the CSI report. The 2N₁N₂×N₃ codebook per layer/takes on the form

Wₗ=W₁W_{2,l},

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${u}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ are “oversampling factors”, assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the L selected columns in B are reported, along with the oversampling index taking on O₁O₂ values. Note that W_{2,l} are independent across different layers.

For NR Rel. 15 Type-II Port Selection Codebook, only K (where K≤2N₁N₂) beamformed CSI-RS ports are utilized in DL transmission, in order to reduce complexity. The K×N₃ codebook matrix per layer takes on the form [1].

Wₗ=W₁^{PS}W_{2,l}.

Here, W_{2,l} follow the same structure as the conventional NR Rel. 15 Type-II Codebook and are layer specific. W₁^{PS} is is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is a radio resource control (RRC) parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback report. W₁^{PS} is common across all layers.

For K=16, L=4 and d_{PS}=1, the 8 possible realizations of E corresponding to m_{PS}={0,1, . . . ,7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook is the baseline codebook for NR, with a variety of configurations. One utility of Rel. 15 Type-I codebook is a case of NR Rel. 15 Type-II codebook with L=1 for RI=1,2, where a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁ . . . =ϕ, e.g., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only. More details on NR Rel. 15 Type-I codebook can be found in R1-1709232, Samsung et al., “WF on Type I and II CSI codebooks,” Hangzhou, China, May 15-19, 2017, hereinafter referenced as [2].

For NR Rel. 16 Type-II Codebook, assume the gNB is equipped with a two-dimensional (2D) antenna array with N₁N₂ antenna ports per polarization (N₁ being the horizontal and N₂ the vertical dimension of the array). In the frequency domain, communication occurs over N₃ PMI sub-bands, where a sub-band includes a set of RBs, each RB including a set of subcarriers. Considering dual-polarization, there are 2N₁N₂ CSI-RS ports are utilized to enable DL channel estimation with high resolution for NR Rel. 16 Type-II codebook. In order to reduce feedback overhead in Uplink (UL), a DFT-based transformation is used to project the channel onto L spatial beams (shared by both polarizations) where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form [1]

Wₗ=W₁−\tilde{W}_{2,l}W_{f,l}^{H},

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript^{T} denotes a matrix transposition operation. Note that O₁, O₂ oversampling factors are assumed for the 2D DFT matrix from which matrix B is drawn. Note that W₁ is common across all layers. W_{f,1} is an N₃×M matrix (M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{M ′ - 1}}\end{matrix} ] , 0 \leq {k}_{i} \leq {N}_{3} - 1 , \\ {f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns in B are reported, along with the oversampling index taking on O₁O₂ values. Similarly, for W_{f,1}, only the indices of the M selected columns out of the predefined size-N₃ DFT matrix are reported. In the sequel the indices of the M dimensions are referred to as the selected Frequency Domain (FD) basis indices. Hence, L, M represent the equivalent spatial and frequency dimensions after compression, respectively. Finally, the 2L×M matrix \tilde{W}_{2,l} represents the linear combination coefficients (LCCs) of the spatial and frequency DFT-basis vectors of layer l. Both \tilde{W}_{2,l}, W_{f,1} are selected independent for different layers. Amplitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, which is much less than the total number of CSI coefficients 2N₁N₂×N₃.

For NR Rel. 16 Type-II Port Selection Codebook, only K (where K≤2N₁N₂) beamformed CSI-RS ports are utilized in DL transmission, in order to reduce complexity. The K×N₃ codebook matrix per layer takes on the form as discussed in [1].

Wₗ=W₁^{PS}\tilde{W}_{2,l}W_{f,l}^{H}.

Here, \tilde{W}_{2,l} and W_{f,1} follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

The NR Rel. 17 Type-II Port Selection Codebook follows a similar structure as that of Rel. 15 and Rel. 16 port-selection codebooks, as follows.

Wₗ=W̅₁^{PS}\tilde{W}_{2,l}W_{f,l}^{H}.

However, unlike Rel. 15 and Rel. 16 Type-II port-selection codebooks, the port-selection matrix W̅₁^{PS} supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,l} and W_{f,1} follow the same structure as the conventional NR Rel. 16 Type-II Codebook, however Mis limited to {1,2} only, with the network configuring a window of size N∈{2,4} for M=2. Moreover, the bitmap is reported unless β=1 and the UE reports all the coefficients for a rank up to a value of two.

For CSI reporting the codebook report is partitioned into two parts based on the priority of information reported. Each part is encoded separately (Part 1 has a possibly higher code rate). Below we list the parameters for NR Rel. 16 Type-II codebook only. More details can be found in clause 5.2.3-4 of [1].

For content of a CSI report:
Part 1: RI+CQI+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can allow dynamic reporting size for codebook based on available resources in the uplink phase. More details can be found in clause 5.2.3 of [1].

Also Type-II codebook is based on aperiodic CSI reporting, and only reported in physical uplink shared channel (PUSCH) via downlink control information (DCI) triggering (one exception). Type-I codebook can be based on periodic CSI reporting (e.g., physical uplink control channel (PUCCH)) or semi-persistent CSI reporting (PUSCH or PUCCH) or aperiodic reporting (PUSCH).

For priority reporting for CSI Part 2, note that multiple CSI reports may be transmitted with different priorities, as shown in Table 1 below. The priority of the N_{Rep} CSI reports are based on the following:
1. A CSI report corresponding to one CSI reporting setting for one cell may have higher priority compared with another CSI report corresponding to one other CSI reporting setting for the same cell.
2. CSI reports intended to one cell may have higher priority compared with other CSI reports intended to another cell.
3. CSI reports may have higher priority based on the CSI report content. For example, CSI reports carrying Layer 1 reference signal received power (L1-RSRP) information have higher priority.
4. CSI reports may have higher priority based on their type. For example, whether the CSI report is aperiodic, semi-persistent or periodic, and whether the report is sent via PUSCH or PUCCH, may impact the priority of the CSI report.

In light of these, CSI reports may be prioritized as follows, where CSI reports with lower identifiers (IDs) have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting setting index, and Ms: Maximum number of CSI reporting settings
c: Cell index, and N_{cells}: Number of serving cells
k: 0 for CSI reports carrying L1-RSRP or Layer 1 signal-to-interference-and-noise ratio (L1-SINR), 1 otherwise
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

For triggering aperiodic CSI reporting on PUSCH, a UE is to report the CSI information for the network using the CSI framework in NR Release 15. The triggering mechanism between a report setting and a resource setting can be summarized in Table 2 below.

TABLE 2
Triggering mechanism between a report setting and a resource setting

| | | | | Access |
|---|---|---|---|---|
| | | | | Point |
| | | Periodic CSI | Semi-Persistent (SP) | (AP) CSI |
| | | reporting | CSI reporting | Reporting |
| Time Domain | Periodic CSI-RS | RRC configured | MAC control | DCI |
| Behavior of | | | element (CE) | |
| Resource Setting | | | (PUCCH) | |
| | | | DCI (PUSCH) | |
| | SP CSI-RS | Not Supported | MAC CE | DCI |
| | | | (PUCCH) | |
| | | | DCI (PUSCH) | |
| | AP CSI-RS | Not Supported | Not Supported | DCI |

Moreover,
All associated Resource Settings for a CSI Report Setting are to have same time domain behavior.
Periodic CSI-RS/interference management (IM) resource and CSI reports can be assumed to be present and active once configured by RRC
Aperiodic and semi-persistent CSI-RS/IM resources and CSI reports can be explicitly triggered or activated.
Aperiodic CSI-RS/IM resources and aperiodic CSI reports, the triggering is done jointly by transmitting a DCI Format 0-1.
Semi-persistent CSI-RS/IM resources and semi-persistent CSI reports are independently activated.

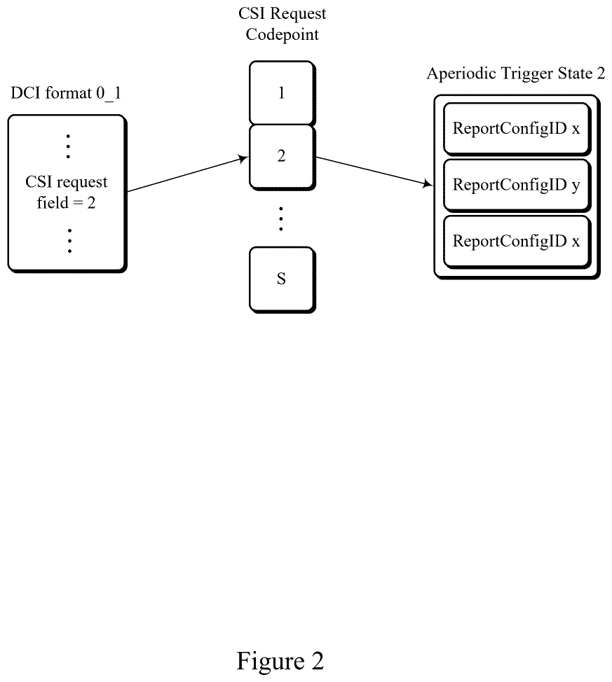

FIG. 2 illustrates aperiodic trigger state defining a list of CSI report settings. For aperiodic CSI-RS/IM resources and aperiodic CSI reports, the triggering is done jointly by transmitting a DCI Format 0-1. The DCI Format 0_1 includes a CSI request field (0 to 6 bits). A non-zero request field points to a so-called aperiodic trigger state configured by RRC (see, e.g., FIG. 2). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

When the CSI Report Setting is linked with aperiodic Resource Setting (can include multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi co-location (QCL) source to use is also configured in the aperiodic trigger state. The UE assumes that the resources used for the computation of the channel and interference can be processed with the same spatial filter e.g. quasi-co-located with respect to “QCL-TypeD.”

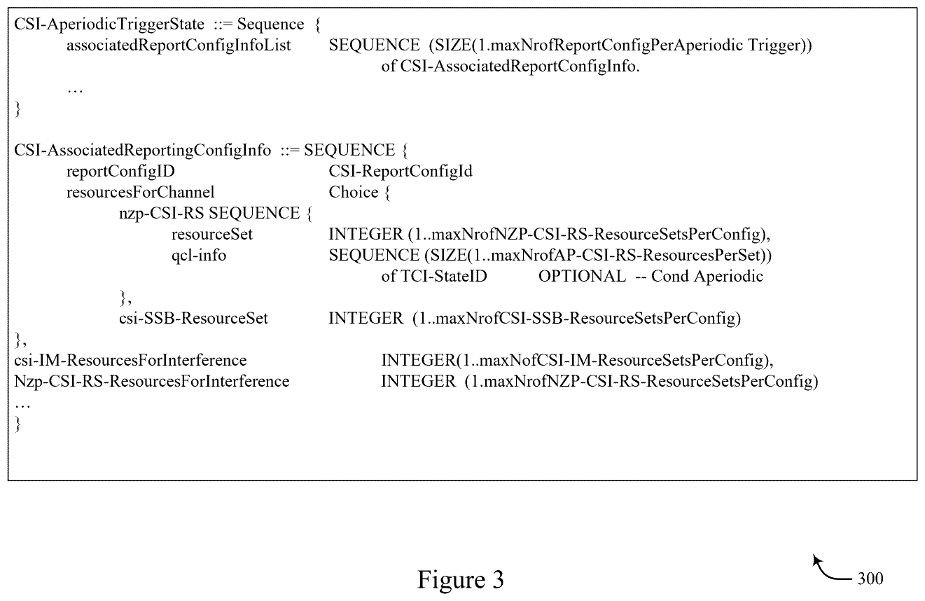

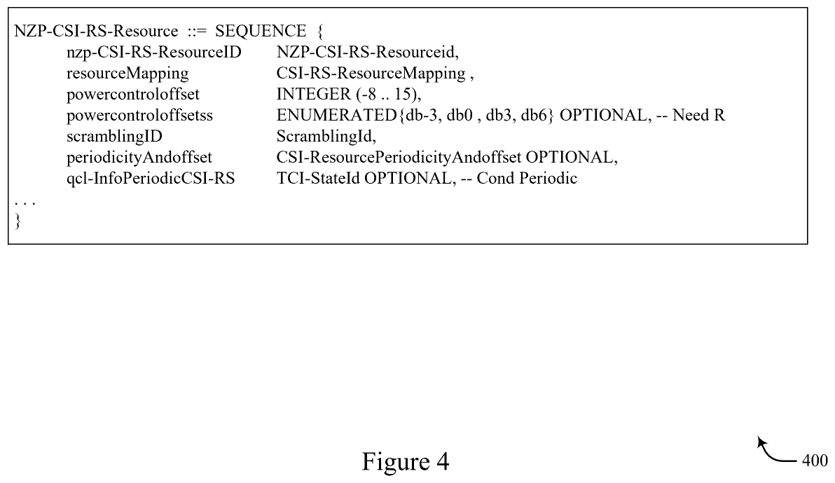

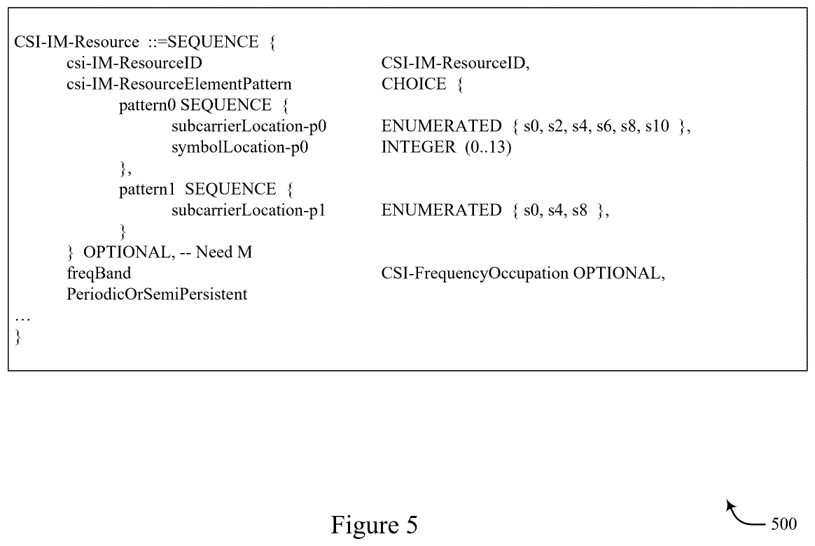

FIG. 3 illustrates at 300 aperiodic trigger state indicating the resource set and QCL information. FIGS. 4 and 5 illustrate RRC configuration for NZP-CSI-RS/CSI-IM resources. For instance, 400 illustrates RRC configuration for NZP-CSI-RS Resource and 500 illustrates RRC configuration for CSI-IM-Resource.

In Table 3 we summarize the type of uplink channels used for CSI reporting as a function of the CSI codebook type.

TABLE 3
Uplink channels used for CSI reporting as a function
of the CSI codebook type

| | Periodic CSI | | AP CSI |
|---|---|---|---|
| | reporting | SP CSI reporting | reporting |
| Type I Wideband | PUCCH | PUCCH Format 2 | PUSCH |
| (WB) | Format 2, 3, 4 | PUSCH | |
| Type I Subband | | PUCCH Format 3, 4 | PUSCH |
| (SB) | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case uplink control information (UCI) payload size design would result in large overhead. CSI Part 1 has a fixed payload size (and can be decoded by the gNB without prior information) and includes the following:
RI (if reported), channel state information reference signal (CRI) (if reported) and CQI for the first codeword,
number of non-zero wideband amplitude coefficients per layer for Type II CSI feedback on PUSCH.

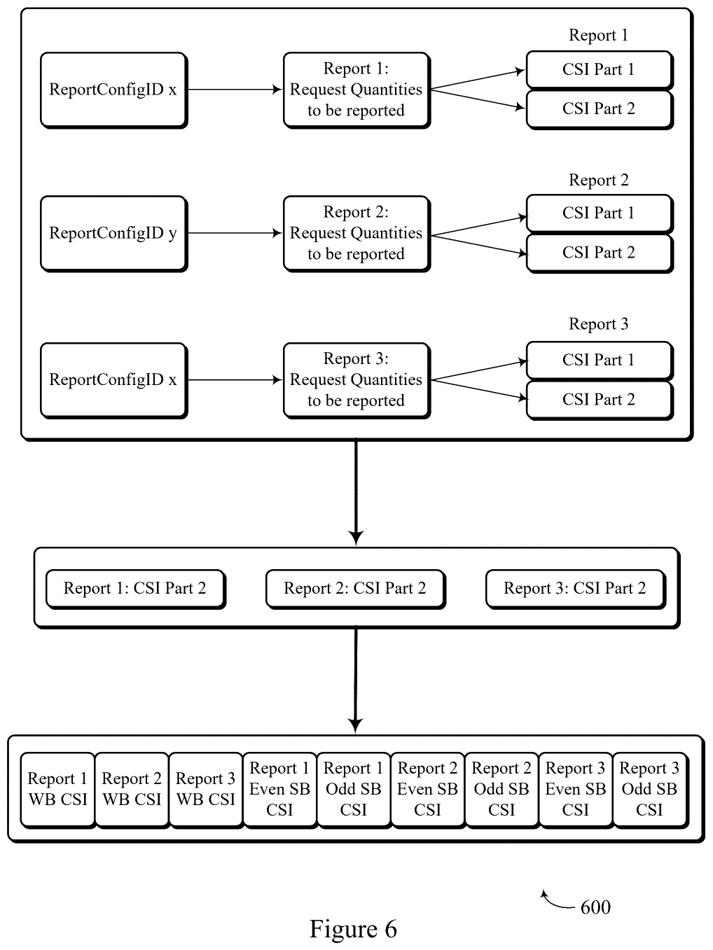

FIG. 6 illustrates at 600 partial CSI omission for Rel. 15 PUSCH-Based CSI. CSI Part 2 has a variable payload size that can be derived from the CSI parameters in CSI Part 1 and includes PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in FIG. 6.

As mentioned earlier, CSI reports are prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

For CQI reporting a CSI report may include a CQI report quantity corresponding to channel quality assuming a target maximum transport block error rate, which indicates a modulation order, a code rate and a corresponding spectral efficiency associated with the modulation order and code rate pair. Examples of the maximum transport block error rates are 0.1 and 0.00001. The modulation order can vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate and efficiency is provided in Table 4 below, as follows.

A CQI value may be reported in two formats: a wideband format, where one CQI value is reported corresponding to each physical downlink shared channel (PDSCH) transport block, and a subband format, where one wideband CQI value is reported for the entire transport block, in addition to a set of subband CQI values corresponding to CQI subbands on which the transport block is transmitted. CQI subband sizes are configurable, and depends on the number of physical resource blocks (PRBs) in a bandwidth part, as shown in Table 5.

TABLE 4
Example of a 4-bit CQI table

| CQI | | code rate × | |
|---|---|---|---|
| index | modulation | 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

TABLE 5
Configurable subband sizes for a
given bandwidth part (BWP) size

| Bandwidth | Subband |
|---|---|
| part | size |
| (PRBs) | (PRBs) |
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6 as follows.

TABLE 6
Mapping subband differential
CQI value to offset level

| Sub-band | |
|---|---|
| differential | Offset |
| CQI value | level |
| 0 | 0 |
| 1 | 1 |
| 2 | ≥2 |
| 3 | ≤−1 |

Also, note that multiple tables corresponding to mapping CQI indices to modulation and coding schemes may exist. For instance, Table 7 below may correspond to a first CQI table with modulation and coding schemes that correspond to enhanced Mobile BroadBand (eMBB)-based transmission, whereas Table 8 below of the CQI may correspond to a first CQI table with modulation and coding schemes that correspond to ultra-reliable low-latency communication (URLLC)-based transmission. Note that eMBB-based DL transmission and URLLC-based DL transmission correspond to two different thresholds of transport block error probability, where the threshold of the transport block error probability corresponding to the URLLC-based DL transmission, e.g., 0.00001 is lower than the threshold of the transport block error probability corresponding to the eMBB-based DL transmission, e.g., 0.1.

TABLE 7
CQI Table corresponding to eMBB-based DL transmission

| CQI | | code rate × | |
|---|---|---|---|
| index | modulation | 1024 | efficiency |
| 0 | out of range | | |
| 1 | QPSK | 78 | 0.1523 |
| 2 | QPSK | 193 | 0.3770 |
| 3 | QPSK | 449 | 0.8770 |
| 4 | 16 QAM | 378 | 1.4766 |
| 5 | 16 QAM | 490 | 1.9141 |
| 6 | 16 QAM | 616 | 2.4063 |
| 7 | 64 QAM | 466 | 2.7305 |
| 8 | 64 QAM | 567 | 3.3223 |
| 9 | 64 QAM | 666 | 3.9023 |
| 10 | 64 QAM | 772 | 4.5234 |
| 11 | 64 QAM | 873 | 5.1152 |
| 12 | 256 QAM | 711 | 5.5547 |
| 13 | 256 QAM | 797 | 6.2266 |
| 14 | 256 QAM | 885 | 6.9141 |
| 15 | 256 QAM | 948 | 7.4063 |

TABLE 8
CQI Table corresponding to URLLC-based DL transmission

| CQI | | code rate × | |
|---|---|---|---|
| index | modulation | 1024 | efficiency |
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16 QAM | 378 | 1.4766 |
| 10 | 16 QAM | 490 | 1.9141 |
| 11 | 16 QAM | 616 | 2.4063 |
| 12 | 64 QAM | 466 | 2.7305 |
| 13 | 64 QAM | 567 | 3.3223 |
| 14 | 64 QAM | 666 | 3.9023 |
| 15 | 64 QAM | 772 | 4.5234 |

For codeword to layer mapping the UE may determine that complex-valued modulation symbols for each of the codewords to be transmitted are mapped onto one or several layers according to Table 9 below. Complex-valued modulation symbols d⁽⁴⁾(0), . . . , d⁽⁴⁾(M_{symb}^{(q)}−1) for codeword q can be mapped onto the layers x(i)=[x⁽⁰⁾(i) . . . x^{(ν-1)}(i)]^{T}, i=0,1, . . . , M_{symb}^{layer}−1 where ν is the number of layers and M_{symb}^{layer} is the number of modulation symbols per layer.

TABLE 9
Codeword-to-layer mapping for spatial multiplexing

| Number | Number of | Codeword-to-layer mapping |
|---|---|---|
| of layers | codewords | i = 0, 1, . . . , M_{symb}^{layer} − 1 |
| 1 | 1 | x⁽⁰⁾(i) = d⁽⁰⁾(i) M_{symb}^{layer} = M_{symb}⁽⁰⁾ |
| 2 | 1 | x⁽⁰⁾(i) = d⁽⁰⁾(2i) M_{symb}^{layer} = M_{symb}⁽⁰⁾/2 |
| | | x⁽¹⁾(i) = d⁽⁰⁾(2i + 1) |
| 3 | 1 | x⁽⁰⁾(i) = d⁽⁰⁾(3i) M_{symb}^{layer} = M_{symb}⁽⁰⁾/3 |
| | | x⁽¹⁾(i) = d⁽⁰⁾(3i + 1) |
| | | x⁽²⁾(i) = d⁽⁰⁾(3i + 2) |
| 4 | 1 | x⁽⁰⁾(i) = d⁽⁰⁾(4i) M_{symb}^{layer} = M_{symb}⁽⁰⁾/4 |
| | | x⁽¹⁾(i) = d⁽⁰⁾(4i + 1) |
| | | x⁽²⁾(i) = d⁽⁰⁾(4i + 2) |
| | | x⁽³⁾(i) = d⁽⁰⁾(4i + 3) |
| 5 | 2 | x⁽⁰⁾(i) = d⁽⁰⁾(2i) M_{symb}^{layer} = M_{symb}⁽⁰⁾/2 = M_{symb}⁽¹⁾/3 |
| | | x⁽¹⁾(i) = d⁽⁰⁾(2i + 1) |
| | | x⁽²⁾(i) = d⁽⁰⁾(3i) |
| | | x⁽³⁾(i) = d⁽¹⁾(3i + 1) |
| | | x⁽⁴⁾(i) = d⁽¹⁾(3i + 2) |
| 6 | 2 | x⁽⁰⁾(i) = d⁽⁰⁾(3i) M_{symb}^{layer} = M_{symb}⁽⁰⁾/3 = M_{symb}⁽¹⁾/3 |
| | | x⁽¹⁾(i) = d⁽⁰⁾(3i + 1) |
| | | x⁽²⁾(i) = d⁽⁰⁾(3i + 2) |
| | | x⁽³⁾(i) = d⁽¹⁾(3i) |
| | | x⁽⁴⁾(i) = d⁽¹⁾(3i + 1) |
| | | x⁽⁵⁾(i) = d⁽¹⁾(3i + 2) |
| 7 | 2 | x⁽⁰⁾(i) = d⁽⁰⁾(3i) M_{symb}^{layer} = M_{symb}⁽⁰⁾/3 = M_{symb}⁽¹⁾/4 |
| | | x⁽¹⁾(i) = d⁽⁰⁾(3i + 1) |
| | | x⁽²⁾(i) = d⁽⁰⁾(3i + 2) |
| | | x⁽³⁾(i) = d⁽¹⁾(4i) |
| | | x⁽⁴⁾(i) = d⁽¹⁾(4i + 1) |
| | | x⁽⁵⁾(i) = d⁽¹⁾(4i + 2) |
| | | x⁽⁶⁾(i) = d⁽¹⁾(4i + 3) |
| 8 | 2 | x⁽⁰⁾(i) = d⁽⁰⁾(4i)M_{symb}^{layer} = M_{symb}⁽⁰⁾/4 = M_{symb}⁽¹⁾/4 |
| | | x⁽¹⁾(i) = d⁽⁰⁾(4i + 1) |
| | | x⁽²⁾(i) = d⁽⁰⁾(4i + 2) |
| | | x⁽³⁾(i) = d⁽⁰⁾(4i + 3) |
| | | x⁽⁴⁾(i) = d⁽¹⁾(4i) |
| | | x⁽⁵⁾(i) = d⁽¹⁾(4i + 1) |
| | | x⁽⁶⁾(i) = d⁽¹⁾(4i + 2) |
| | | x⁽⁷⁾(i) = d⁽¹⁾(4i + 3) |

The following discusses antenna panel/port, quasi-collocation, TCI state, and spatial relation. In some implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel can include biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For at least some condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where the UE may not be able to perform omni-directional transmission, e.g. the UE may determine to form beams for directional transmission. A QCL-TypeD between two reference signals A and B, the reference signal A is considered to be spatially co-located with reference signal B and the UE may assume that the reference signals A and B can be received with the same spatial filter (e.g., with the same receiver (RX) beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a Transmission Configuration Indication (TCI) state associated with a target transmission can indicate parameters for configuring a quasi-collocation relationship between the target transmission (e.g., target RS of demodulation reference signal (DM-RS) ports of the target transmission during a transmission occasion) and a source reference signal(s) (e.g., synchronization signal block (SSB)/CSI-RS/sounding reference signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Accordingly, implementations described herein provide for enhanced CSI techniques, such as for accommodating larger antenna arrays. For purposes of the discussion herein consider the following: We use the following notions interchangeably: network nodes, transmit-receive point (TRP), panel, set of antennas, set of antenna ports, uniform linear array, cell, node, radio head, communication (e.g., signals/channels) associated with a CORESET (control resource set) pool, communication associated with a TCI state from a transmission configuration including at least two TCI states.

The codebook type used for PMI reporting is arbitrary; flexibility for use different codebook types, e.g., Type-II Rel. 16 codebook, Type-II Rel. 17 codebook, Type-II Rel. 18 codebook etc. A tracking reference signal (TRS) can correspond to an NZP CSI-RS resource set with a parameter ‘trs-info’ being configured. A CSI-RS for beam management can correspond to an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix implies a sequence of fields of an arbitrary dimension, including an array (vector) of values, a standard 2D matrix and more generally a Q-dimensional matrix (tensor) where Q≥2 is an integer value. Several implementations are described herein. According to implementations, one or more elements or features from one or more of the described implementations may be combined.

Implementations described herein provide for indications of enhanced codebook design. A network can configure a UE with CSI reporting where the CSI reporting corresponds to a large number of overall CSI-RS ports, e.g., more than 32 CSI-RS ports. An indication of a configuration corresponding to enabling the UE to report CSI corresponding to a large number of ports can be a combination of one or more of the following.

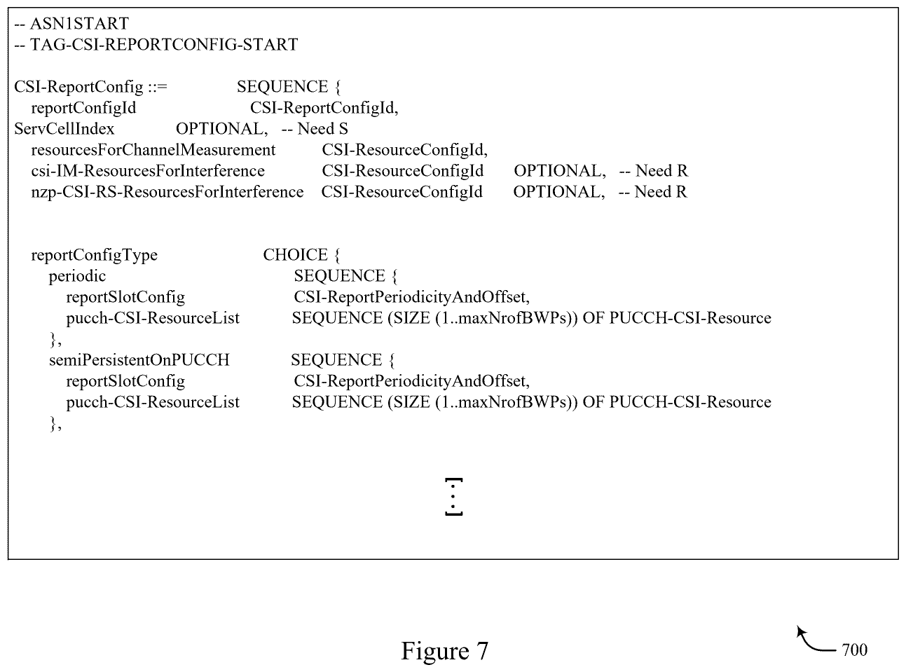

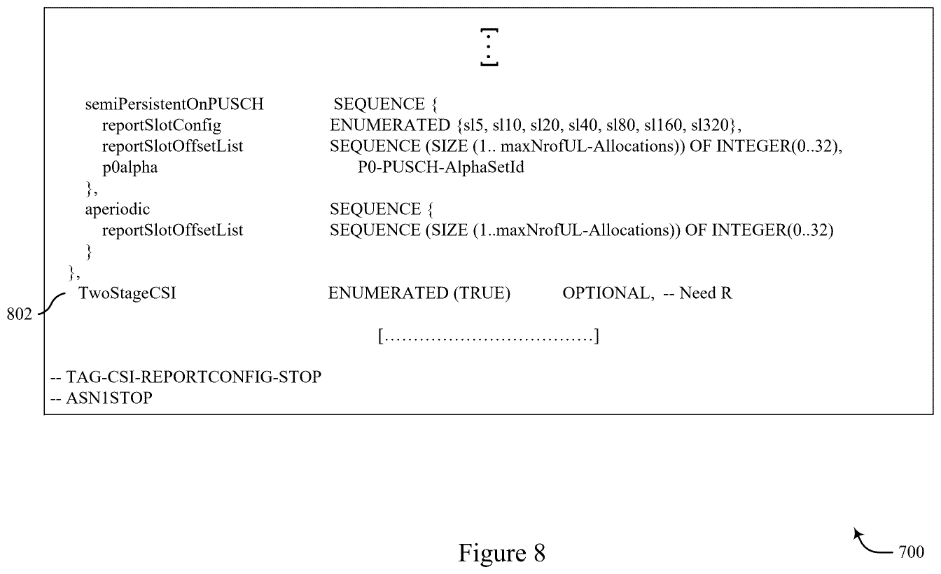

FIGS. 7 and 8 illustrate different respective portions an example information element (IE) 700 in accordance with aspects of the present disclosure. In implementations as part of the IE 700 a higher-layer parameter 802 (e.g., TwoStageCSJ) within the CSI-ReportConfig CSI Reporting Setting information element IE configures the UE with CSI measurement and reporting corresponding to a large number of overall CSI-RS ports, e.g., more than 32 CSI-RS ports. The higher-layer parameter 802 may appear in different sub-elements of the Reporting Setting IE. The IE 700, for instance, includes an example of ASN.1 code such as for the CSI-ReportConfig Reporting Setting IE. An example foundation for the ASN.1 code for this IE (e.g., prior to the novel modification herein) can be found in Clause 6.3.2 of 3GPP TS 38.331, “Radio Resource Control (RRC) protocol specification,” December 2022, hereinafter referenced as [3].

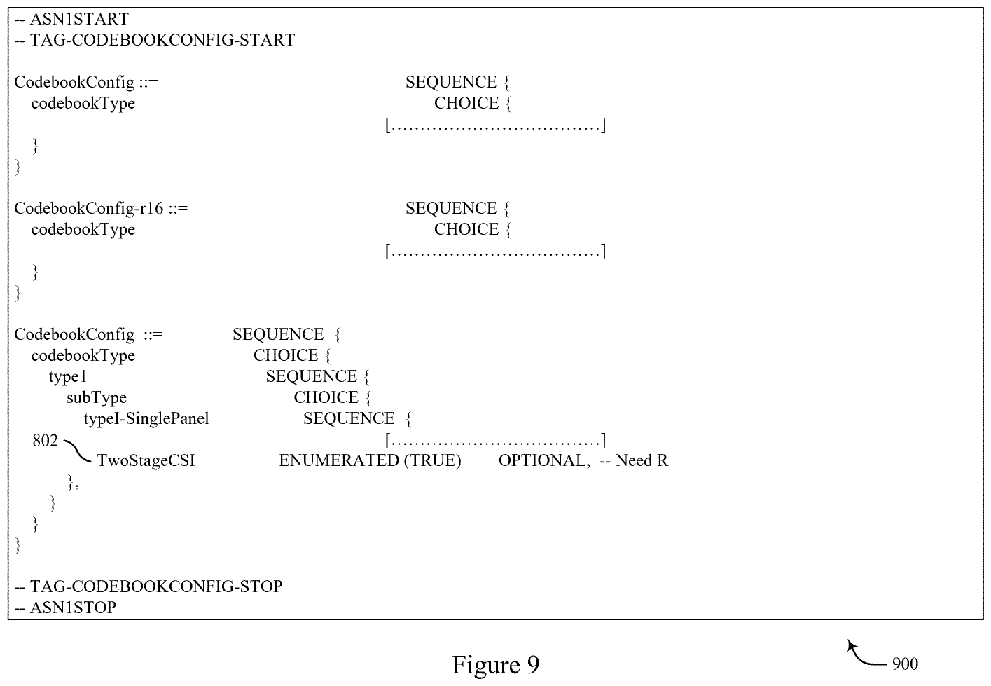

FIG. 9 illustrates an example IE 900 in accordance with aspects of the present disclosure. In the IE 900, for instance, the higher-layer parameter 802 (e.g., TwoStageCSJ) is configured within the Codebook Configuration CodebookConfg IE, e.g., CodebookConfig-r19 is used. An example foundation of the ASN.1 code for this IE (e.g., prior to the novel modification herein) that corresponds to the last can be found in Clause 6.3.2 of [3].

In implementations the CSI reporting for a large number of CSI-RS ports is associated with a distinct codebook type associated with the CSI reporting setting, e.g., Type-II Rel-19, or Type-I Rel-19.

In implementations for codebook design we can denote the horizontal and vertical dimensions of the transmit antenna array by the pair (Ñ₁,Ñ₂) and we reserve the notation (N₁, N₂) for the supported legacy antenna array dimensions with N₁N₂≤16. A list of legacy supported antenna array configurations is given in Table 5.2.2.2.1-2 of [1]. Different implementations are described below. According to a possible implementation, a combination of one or more implementations is not precluded.

The described enhanced codebook design supports at least one of two modes, a first mode (Mode 1) corresponding to an extension of legacy PMI codebook to larger numbers of antenna ports, and a second mode (Mode 2) corresponding to a two-stage codebook design. Both modes are described in detail herein.

For Mode 1 and considering extension of legacy PMI codebook, legacy codebook designs are extended to more than 32 ports, e.g., the dimensions of N₁, N₂ are extended such that N₁N₂>16.

In a first example, the legacy codebook is at least one of the following codebooks: Rel-15 Type-I Single Panel codebook, Rel-16 eType-II codebook, Rel-17 FeType-II codebook, or Rel-18 Type-II Doppler codebook. In a second example, the following values are supported for the pair (N₁, N₂) corresponding to a total number of CSI-RS ports up to 128, as shown in Table 1.

TABLE 1
Examples of supported configurations (N₁, N₂)
for up to 128 CSI-RS ports

| Number | |
|---|---|
| of CSI-RS | |
| Ports | (N₁, N₂) |
| 4 | (2, 1) |
| 8 | {(2, 2), (4, 1)} |
| 12 | {(3, 2), (6, 1)} |
| 16 | {(4, 2), (8, 1)} |
| 24 | {(4, 3), (6, 2), (12, 1)} |
| 32 | {(4, 4), (8, 2), (16, 1)} |
| 48 | {(6, 4), (8, 3), (12, 2), (24, 1)} |
| 64 | {(8, 4), (16, 2), (32, 1)} |
| 96 | {(8, 6), (12, 4), (16, 3), |
| | (24, 2), (48 ,1)} |
| 128 | {(8, 8), (16, 4), (32, 2), (64, 1)} |

For Mode 2 and considering two-stage PMI codebook design, to reduce the overhead and complexity of CSI feedback, the first stage of the two-stage precoding mechanism acts as a projector that projects the CSI from a space of dimension 2Ñ₁Ñ₂ to a space of dimension 2N, where N∈{2, 4, 6, 8, 12, 16}. The first stage can project the CSI-RS ports to a set of “virtual ports” of reduced size. Then in the second stage of the two-stage precoding mechanism, we apply a precoding matrix which is chosen from a legacy Type-I or Type-II PMI codebook to the reduced dimension “virtual channel”. Otherwise stated, the two-stage precoding amounts to aggregating subsets of antenna ports into 2N̅ single virtual ports, followed by a legacy precoder. To state this more clearly, we may consider the DL signal model of transmission with an array of Nₜₓ=2Ñ₁Ñ₂ CSI-RS ports and reception of Nᵣₓ ports at the UE side. The UE receives the following signal at transmission layer l and at a single sub-carrier of sub-band n:

$${y}_{n} = {\sum }_{l = 1}^{R} {H}_{n} {W}_{l , n} {s}_{l , n} + {z}_{n} = {\sum }_{l = 1}^{R} {H}_{n} {V}_{l , n} {W}_{l , n}^{( legacy )} {s}_{n , l} + {z}_{n}$$

where Hₙ is the channel matrix of dimension Nᵣₓ×2Ñ₁Ń₂, W_{l,n} is the precoding vector of dimension 2Ñ₁Ñ₂ for layer l at sub-band n, s_{l,n} is the scalar transmit symbol, R is the number of layers, V_{l,n} is a matrix of dimension 2Ñ₁Ñ₂×2N̅ representing the first stage of the two-stage precoder where N̅<Ñ₁Ñ₂, W_{l,n}^{(legacy)} is a vector of dimension 2N which is taken from a legacy codebook, which represents the second stage of the two-stage precoding. The product HₙV_{l,n} is of dimension Nᵣₓ=2N and can be seen as the virtual channel, resulting from the application of V_{l,n} to Hₙ. Then the component W_{l,n}^{(legacy)} chosen from the legacy precoder, is applied to this virtual channel.

In a two-stage PMI codebook design, the elements of the codebook are designed such that the precoding vector at sub-band n and layer l is given by the following product

$${W}_{l , n} = {V}_{l , n} \times {W}_{l , n}^{( legacy )} ,$$

where V_{l,n} corresponding to a first stage of the two-stage PMI, is a complex-valued matrix of dimension 2Ñ₁Ñ₂×2N̅ where we have defined N̅≙ N̅₁N̅₂, N̅₁≤Ñ₁ and N̅₂≤Ñ₂. W_{l,n}^{(legacy)} corresponding to a second stage of the two-stage PMI, is a complex-valued vector of dimension 2N belonging to the legacy Type-I or Type-II PMI codebooks, e.g., Type-I Rel. 15 single-panel codebook, Type-II Rel. 16 codebook, Type-II Rel. 17 codebook, Type-II Rel. 18 Doppler codebook, etc.

In a first example, a value of N̅ includes at least one of {2, 4, 6, 8, 12, 16}, where N̅ is an intermediate “reduced” dimension, where N̅<Ñ₁Ñ₂. In a second example, a value of each of \hat{N}₁, N̅₂ includes at least one of {2, 4, 6, 8, 12, 16}, where N̅₁<Ñ₁, N̅₂<Ñ₂. In a third example, the values of N̅₁, N̅₂ correspond to the values N₁, N₂, respectively, in legacy PMI codebooks, e.g., N̅₁=N₁, N̅₂=N₂, and the value of N̅ corresponds to the number of CSI-RS ports, P_{CSI-RS}, e.g., N̅₁→P_{CSI-RS}/2. In a fourth example, 2Ñ₁Ñ₂>32. A maximum value of 2N̅₁Ñ₂ can be up to 128. In a fifth example, the matrix V_{l,n} is sub-band specific and layer-specific, e.g. a value of the first-stage PMI is distinctly chosen for each sub-band n and layer l.

In a sixth example, the matrix V_{l,n} is sub-band specific but common among all layers, e.g. V_{l,n}=V_{1′,n} for some n and all l≠l′. In a seventh example, the matrix V_{l,n} is layer specific but common among all sub-bands, e.g. V_{l,n′}=V_{l,n} for some l and all n≠n′.

Next, we will discuss two designs for the first stage of the precoder, e.g., the matrix V_{l,n}. Although the selection can be independent for each layer and sub-band, we drop the layer and sub-band indices l, n in the sequel for simplicity and discuss the design of matrix V. To generalize, the following does not preclude the design of a layer-dependent or sub-band dependent first stage matrix V.

In this section, we propose two designs for the first component of the precoding matrix. Assuming dual-polarized antennas, we represent V in both designs as a block-diagonal matrix,

$$V = [ \begin{matrix}\tilde{V} & 0 \\ 0 & \tilde{V}\end{matrix} ] ,$$

where \tilde{V} is an Ñ₁Ñ₂×N̅₁N̅₂ matrix. The two designs (e.g., Design 1 and Design 2) construct this matrix in different ways.

In Design 1, \tilde{V} is a “port selection matrix” of dimension Ñ₁Ñ₂×N̅₁N̅₂. Let [symbol] ={m₀, . . . , m_{N̅}_{₁}_{N̅}_{₂}₋₁}⊆{0,1, . . . , Ñ₁Ñ₂−1} be a subset of antenna port indices of size | [symbol] |=N̅₁N̅₂. In a first example, the columns of \tilde{V} are given as

$${[ \tilde{V} ]}_{. , j} = {e}_{{m}_{j}}^{{\tilde{N}}_{1} {\tilde{N}}_{2}} , j = 0 , 1 , … , {\overline{N}}_{1} {\overline{N}}_{2} - 1 ,$$

where eₓ^{y} is the standard unit vector of dimension y, which includes elements all equal to 0 except for an element in location x equal to 1. When applied to the CSI, the action of \tilde{V} amounts to sampling the CSI on a subset of antennas indexed by the set [symbol] . In other words, \tilde{V} maps the original antenna ports to “virtual ports” including antennas indexed by the set [symbol] .

The second stage of the precoding includes a precoder Wₗ^{(legacy)} corresponding to a Type-I or Type-II PMI codebook. To choose Wₗ^{(legacy)}, values of the dimensional parameters N₁ and N₂ such that N₁N₂=N̅₁N̅₂ are supported. The supported dimensions (N₁, N₂) in legacy codebooks are provided, e.g. in Table 5.2.2.2.1-2 of [1]. These are the following set of values

$$\tilde{ℂ} = \{ ( 2 , 1 ) , ( 2 , 2 ) , ( 4 , 1 ) , ( 3 , 2 ) , ( 6 , 1 ) , ( 4 , 2 ) , ( 8 , 1 ) , ( 4 , 3 ) , ( 6 , 2 ) , ( 12 , 1 ) , ( 4 , 4 ) , ( 8 , 2 ) , ( 16 , 1 ) \} .$$

This puts a constraint on the reduced dimension N̅₁N̅₂. In particular, the supported values are given as:

$$ℂ = \{ ( {N}_{1} , {N}_{2} ) \vert {N}_{1} {N}_{2} ∈ \{ 2 , 4 , 6 , 8 , 12 , 16 \} \} .$$

For a fixed (N̅₁,N̅₂), since there are

$$( \begin{matrix}{\tilde{N}}_{1} & {\tilde{N}}_{2} \\ {\overline{N}}_{1} & {\overline{N}}_{2}\end{matrix} )$$

different choices of selecting the indices [symbol] above, to report V the UE has to feedback

$$( \begin{matrix}{\tilde{N}}_{1} & {\tilde{N}}_{2} \\ {\overline{N}}_{1} & {\overline{N}}_{2}\end{matrix} )$$

NⱼN₂ bits to the network.

As an example consider a transmit antenna array of dimension (Ñ₁, Ñ₂)=(8,4) and a selected virtual array dimension of (N̅₁, N̅₂)=(4,2). One choice of an arbitrary port indices is given by {2,3,5,8,13,21,27,30}. The matrix V is given in this case as

$$\tilde{V} = [ {e}_{2}^{32} , {e}_{3}^{32} , {e}_{5}^{32} , {e}_{8}^{32} , {e}_{13}^{32} , {e}_{21}^{32} , {e}_{27}^{32} , {e}_{30}^{32} ] .$$

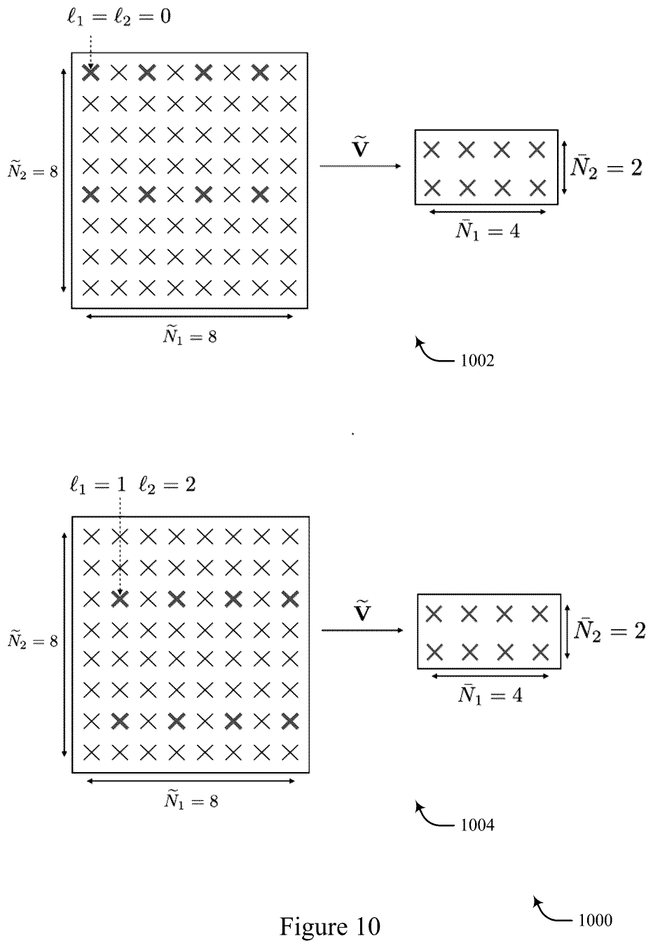

In another example, the index set [symbol] is chosen as a discrete 2D uniform grid, defined below, such that the selected ports form a uniform planar array (see, e.g., FIG. 10 and discussion below). To introduce this, we first provide the following definitions.

Notation: For a non-negative integer i, define [i]={0,1, . . . , i−1} as the set of integers from 0 to i−1. Also define D(i)=j| mod(i, j)=0} as the set of divisors of i.

Definition (Discrete 2D Uniform Grid): For fixed integers M and N and for given

$$( m , n , k , l ) ∈ D ( M ) \times D ( N ) \times [ \frac{M}{m} ] \times [ \frac{N}{n} ] ,$$

we define the discrete 2D uniform grid as the following set of ordered pairs of integer indices:

$$G ( M , N , m , n , k , l ) = \{ ( k + i \frac{M}{m} , l + j \frac{N}{n} ) , i = 0 , 1 , … , m - 1 , j = 0 , 1 , … , n - 1 \} ⊆ [ M ] \times [ N ] .$$

Definition (Uniform Selection Matrix): For fixed integers M and N and for given

$$( m , n , k , l ) ∈ D ( M ) \times D ( N ) \times [ \frac{M}{m} ] \times [ \frac{N}{n} ] ,$$

a selection matrix associated with G(M, N, m, n, k, l) is a matrix of dimension MN×mn, in which each column is a standard unit vector corresponding to a unique element in G(m, n, k, l), given as follows:

$${[ S ( M , N , m , n , k , l ) ]}_{, . j} = {e}_{f ( j )}^{MN} , \qquad j = 0 , … , mn - 1 ,$$

where eₓ^{y} is the standard unit vector of dimension y, which includes elements all equal to 0 except for an element in location x equal to 1, and where

$$f ( j ) = M ( \frac{N}{n} ) ⌊ \frac{j}{m} ⌋ + mod ( j , m ) \frac{M}{m} + l M + k .$$

In the second example, \tilde{V} is a selection matrix, as defined above, corresponding to a discrete uniform 2D grid G(Ñ₂, Ñ₁, N̅₂, N̅₁, [symbol] ₂, [symbol] ₁)⊆[Ñ]×[Ñ₁], e.g.

$$\tilde{V} = S ( {\tilde{N}}_{2} , {\tilde{N}}_{1} , {\overline{N}}_{2} , {\overline{N}}_{1} , {ℓ}_{2} , {ℓ}_{1} )$$

When applied to the CSI, the action of \tilde{V} amounts to a selection of the CSI of a subset of antennas, represented by G(Ñ₂, Ñ₁, N̅₂, N̅₁, [symbol] ₂, [symbol] ₁) in the transmit antenna array of dimension Ñ₂×Ñ₁, hence reducing the dimension of the CSI from Ñ₁Ñ₂ to N̅₁N̅₂. According to this design, the j-th column of \tilde{V} is given by

[\tilde{V}]_{.,j}=e_{f(j)}^{Ñ}^{₁}^{Ñ}^{₂},

where

$$f ( j ) = {\tilde{N}}_{2} ( \frac{{\tilde{N}}_{1}}{{\overline{N}}_{1}} ) ⌊ \frac{j}{{\overline{N}}_{2}} ⌋ + mod ( j , {\overline{N}}_{2} ) \frac{{\tilde{N}}_{2}}{{\overline{N}}_{2}} + {ℓ}_{1} {\tilde{N}}_{2} + {ℓ}_{2}$$

denotes the location of the single element equal to 1 in column j and equivalently the j-th selected antenna. Note that [symbol] ₁ and [symbol] ₂ denote the offset values associated with the index of the first sampled antenna element in horizontal and vertical directions, respectively.

FIG. 10 illustrates an implementation 1000 in accordance with aspects of the present disclosure. The implementation 1000, for instance, includes a first portion 1002 and a second portion 1004 that illustrate two respective examples of the action of \tilde{V} according to this design. For instance, action of the first stage of the proposed precoder \tilde{V} according to Design 1. In both portions 1002, 1004, the array dimension is (Ñ₁, Ñ₂)=(8, 8), and the dimension of the virtual array is (N̅₁, N̅₂)=(4, 2). In the portion 1002 the horizontal and vertical offsets are ( [symbol] ₂, [symbol] ₁)=(0, 0), while in the portion 1004 they are ( [symbol] ₂, [symbol] ₁)=(2, 1).

In an example consider a transmit antenna array of dimension (Ñ₁, Ñ₂)=(8,8). Suppose the selected virtual array dimension and vertical and horizontal offset values are given by the quadruple (N̅₂, N̅₁, [symbol] ₂, [symbol] ₁)=(2,4,2, 1). The matrix \tilde{V} is given in this case as

$$\tilde{V} = [ {e}_{10}^{32} , {e}_{14}^{32} , {e}_{26}^{32} , {e}_{30}^{32} , {e}_{42}^{32} , {e}_{46}^{32} , {e}_{58}^{32} , {e}_{62}^{32} ] .$$

This example, for instance, corresponds to the portion 1004.

From the definitions above, for a given transmit antenna array of dimensions (Ñ₁, Ñ₂), configuring the quadruple (N̅₂, N̅₁, [symbol] ₂, [symbol] ₁) uniquely determines \tilde{V}. Note that there are two constraints on the configuration of the virtual array dimensions (N̅₁, N̅₂):
1. N̅₁ and N̅₂ may be divisors of Ñ₁ and Ñ₂, respectively, namely as mentioned above

$$( {\overline{N}}_{1} , {\overline{N}}_{2} ) ∈ {ℂ}_{1} ( {\tilde{N}}_{1} , {\tilde{N}}_{2} ) {=}^{Δ} D ( {\tilde{N}}_{1} ) \times D ( {\tilde{N}}_{2} )$$

2. (N̅₁, N̅₂) may be a supported configuration in legacy codebooks. All supported configurations are given in Table 5.2.2.2.1-2 of [1]. These are given as the following set of (Ñ₁, Ñ₂) pairs:

$$\tilde{ℂ} = \{ ( 2 , 1 ) , ( 2 , 2 ) , ( 4 , 1 ) , ( 3 , 2 ) , ( 6 , 1 ) , ( 4 , 2 ) , ( 8 , 1 ) , ( 4 , 3 ) , ( 6 , 2 ) , ( 12 , 1 ) , ( 4 , 4 ) , ( 8 , 2 ) , ( 16 , 1 ) \} .$$

Combining these constraints, we arrive at the conclusion that the virtual array dimensions are restricted to the set [symbol] (Ñ₁, Ñ₂) [symbol] [symbol] ₁(Ñ₁, Ñ₂)∩ [symbol] , e.g. (N̅₁,N₂)∈ [symbol] (Ñ₁, Ñ₂). By means of example, we have provided the set [symbol] (Ñ₁, Ñ₂), e.g., (N̅₁, N̅₂), where a number of antenna elements in each of the two spatial dimensions is an integer multiple of a number of antenna elements in the subset of antennas at the corresponding spatial dimensions, as shown in Table 11 below.

TABLE 11
Examples of supported configurations of the virtual array
for given antenna array configuration

| Number | | |
|---|---|---|
| of CSI-RS | | [symbol] (Ñ₁, Ñ₂): Set of supported |
| Ports | (Ñ₁, Ñ₂) | configurations of the virtual array (N̅₁, N̅₂) |
| 4 | (2, 1) | {(2, 1)} |
| 8 | (2, 2) | {(2, 1), (2, 2)} |
| 8 | (4, 1) | {(2, 1), (4, 1)} |
| 12 | (3, 2) | {(3, 1), (3, 2)} |
| 12 | (6, 1) | {(2, 1), (3, 1), (6, 1)} |
| 16 | (4, 2) | {(2, 1), (2, 2), (4, 1), (4, 2)} |
| 16 | (8, 1) | {(2, 1), (4, 1), (8, 1)} |
| 24 | (4, 3) | {(2, 1), (4, 1), (4, 3)} |
| 24 | (6, 2) | {(2, 1), (2, 2), (3, 1), (3, 2), (6, 1), (6, 2)} |
| 24 | (12, 1) | {(2, 1), (3, 1), (4, 1), (6, 1), (12, 1)} |
| 32 | (4, 4) | {(2, 1), (2, 2), (4, 1), (4, 2), (4, 4)} |
| 32 | (8, 2) | {(2, 1), (2, 2), (4, 1), (4, 2), (8, 1), (8, 2)} |
| 32 | (16, 1) | {(2, 1), (4, 1), (8, 1), (16, 1)} |
| 48 | (6, 4) | {(2, 1), (2, 2), (3, 1), (3, 2), (6, 1), (6, 2)} |
| 48 | (8, 3) | {(2, 1), (4, 1), (4, 3), (8, 1)} |
| 48 | (12, 2) | {(2, 1), (2, 2), (3, 1), (3, 2), (4, 1), (4, 2), |
| | | (6, 1), (6, 2), (12, 1)} |
| 48 | (24, 1) | {(2, 1), (3, 1), (4, 1), (6, 1), (8, 1), (12, 1)} |
| 64 | (32, 1) | {(2, 1), (4, 1), (8, 1), (16, 1)} |
| 64 | (16, 2) | {(2, 1), (2, 2), (4, 1), (4, 2), |
| | | (8, 1), (8, 2), (16, 1)} |
| 64 | (8, 4) | {(2, 1), (2, 2), (4, 1), (4, 2), (4, 4), (8, 1), |
| | | (8, 2), (16, 1)} |
| 96 | (48, 1) | {(2, 1), (3, 1), (4, 1), (6, 1), (8, 1), (12, 1), |
| | | (16, 1)} |
| 96 | (24, 2) | {(2, 1), (2, 2), (3, 1), (3, 2), (4, 1), (4, 2), |
| | | (6, 1), (6, 2), (8, 1), (8, 2), (12, 1)} |
| 96 | (16, 3) | {(2, 1), (4, 1), (4, 3), (8, 1), (16, 1)} |
| 96 | (12, 4) | {(2, 1), (2, 2), (3, 1), (3, 2), (4, 1), |
| | | (4, 2), (4, 4), |
| | | (6, 1), (6, 2), (12, 1)} |
| 96 | (8, 6) | {(2, 1), (2, 2), (4, 1), (4, 2), (4, 3), (8, 1), |
| | | (8, 2)} |
| 128 | (64, 1) | {(2, 1), (4, 1), (8, 1), (16, 1)} |
| 128 | (32, 2) | {(2, 1), (2, 2), (4, 1), (4, 2), (4, 4), (8, 1), |
| | | (8, 2), (16, 1)} |
| 128 | (16,4) | {(2, 1), (2, 2), (4, 1), (4, 2), (4, 4), (8, 1), |
| | | (8, 2), (16, 1)} |
| 128 | (8, 8) | {(2, 1), (2, 2), (4, 1), (4, 2), (4, 4), (8, 1), |
| | | (8, 2)} |

Depending on the configuration of the virtual array (N₁, N₂), the second matrix component Wₗ^{(legacy)} of the precoder, e.g. the second precoding stage, is chosen from one of the legacy Rel-15 Type-I Single Panel codebook, Rel-16 eType-II codebook, Rel-17 FeType-II codebook, or Rel-18 Type-II Doppler codebook.

Two examples are discussed above for Design (1) based on antenna selection of the first stage of the precoder based on designing \tilde{V} as an antenna selection matrix, where in the first example, the set of selected antennas of a given size are chosen arbitrarily and in the second one, they are chosen such that the selected set of ports forms a uniform planar virtual array. The second example is a special case of the first, and (1) the emerging uniform planar structure of the virtual array which is matched to the subsequent application of the second stage of the two-stage precoder, since the legacy codebooks can be designed for uniform planar arrays. (2) The number of possibilities in choosing \tilde{V} is smaller compared to the case of arbitrary selections, which reduces the additional feedback overhead.

In implementations the product value N̅ [symbol] N̅₁N̅₂ is network configured, e.g., the network provides the value N̅ as part of the CSI reporting setting, whereas the UE, selects and reports an indication of the value pair (N̅₁, N̅₂), based on the total number of CSI-RS ports, P_{CSI-RS}, and based on the configured antenna configuration, (Ñ₁, Ñ₂).

In a first example, for a configuration corresponding to a total number of 64 ports with (Ñ₁, Ñ₂)=(8,4), and N̅=16, the UE selects and reports an indicator corresponding to a selection of one of {(4,4), (8,2), (16,1)}. More generally, for a given row of Table, the UE selects only from the pair(s) of (N̅₁, N̅₂) values matching the configured value N̅. In a second example, the reported pair of values (N̅₁, N̅₂) is reported on CSI Part 2 of the CSI report, e.g., in a first group of CSI Part 2.

In implementations the UE selects and reports an indication of the value pair (N̅₁, N̅₂) in the CSI report, based on the total number of CSI-RS ports, P_{CSI-RS}, and based on the configured antenna configuration, (Ñ₁, Ñ₂). In a first example, for a configuration corresponding to a total number of 64 ports with (Ñ₁, Ñ₂)=(16,2), the UE selects and reports an indicator corresponding to a selection of one of {(2,1), (2,2), (4,1), (4,2), (4,4), (8,1), (8,2), (16,1)}. For instance, for a given row of Table 11, the UE selects any pair of (N̅₁, N̅₂) values. In a second example, the reported pair value of (N̅₁, N̅₂) is reported on CSI Part 1 of the CSI report.

In implementations the UE is configured with a value of a ratio N̅₁/N̅₂, where the UE selects a pair of (N̅₁, N̅₂) values matching the configured value of the ratio N̅₁/N̅₂, and reports it in the CSI report. In a first example, for a configuration corresponding to a total number of 64 ports with (Ñ₁, Ñ₂)=(8,4), and a value of the ratio N̅₁/N̅₂ is configured to be set to 4, the UE selects and reports an indicator corresponding to a selection of one of {(4,1), (8,2)}. In a second example, the reported pair value of (N̅₁, N̅₂) is reported on CSI Part 1 of the CSI report.

In implementations the UE is configured with reporting an index of a reference port in the CSI report, e.g., an index pair ( [symbol] ₁, [symbol] ₂) identifying the reference port is reported in the CSI report. In a first example, the index pair ( [symbol] ₁, [symbol] ₂) is reported in CSI Part 2 of the CSI report, e.g., in a first group of CSI Part 2. In a second example, each of the elements of the index pair takes on a value satisfying 0≤ [symbol] ₁≤Ñ₁−1, and 0≤ [symbol] ₂≤N₂−1. In a third example, each of the elements of the index pair takes on a value satisfying 0≤ [symbol] ₁≤Ñ₁/N̅₁−1, and 0≤ [symbol] ₂≤Ñ₂/N̅₂−1, where Ñ₁, Ñ₂ are integer multiples of N̅₁, N̅₂, respectively. In a fourth example, each of the elements of the index pair takes on a value satisfying 0≤ [symbol] ₁≤┌Ñ₁/N̅₁┐−1, and 0≤ [symbol] ₂≤┌Ñ₂/N̅₂┐−1.

In implementations the UE selects and reports an indication of an NZP CSI-RS resource, e.g., CRI, corresponding to a selected set of ports, in the CSI report. Under this implementation, the UE is configured with a CSI resource setting corresponding to an NZP CSI-RS resource set for channel measurement including a plurality of NZP CSI-RS resources. In a first example, a number of CSI-RS ports per NZP CSI-RS resource is 2N̅₁N̅₂. In a second example, a number of NZP CSI-RS resources in the NZP CSI-RS resource set for channel measurement is

$$\frac{{\tilde{N}}_{2}}{{\overline{N}}_{2}} \frac{{\tilde{N}}_{1}}{{\overline{N}}_{1}} .$$

For Design (2) including port combining, the matrix \tilde{V} is constructed such that it projects the CSI of dimension Ñ₁Ñ₂ to a lower dimension of N̅₁N̅₂ by taking linear combinations (LCs) of the CSI over rectangular sub-arrays of dimension (\dot{N}₁, \dot{N}₂), where we have defined

$${\dot{N}}_{1} {=}^{Δ} \frac{{\tilde{N}}_{1}}{{\overline{N}}_{1}} and {\dot{N}}_{2} {=}^{Δ} \frac{{\tilde{N}}_{2}}{{\overline{N}}_{2}} .$$

In other words, in contrast to Design 1 where the CSI in certain elements of the array is sampled, Design 2 can take LC of subsets of ports of size (\dot{N}₁, \dot{N}₂), called sub-arrays. These sub-arrays can be overlapping and the LC coefficients are generally chosen separately for each of them. Define S={s₀^{(j)}, . . . , s_{\dot{N}}_{₁}_{\dot{N}}_{₂}₋₁^{(j)}}⊆{0,1, . . . , Ñ₁, Ñ₂−1} as the set of ascendingly ordered indices corresponding to the ports in sub-array j and g^{(j)} [symbol] [g₀^{(j)}, . . . , g_{\dot{N}}_{₁}_{\dot{N}}_{₂}₋₁^{(j)}]^{T} as the complex-valued vector of LC coefficients of dimension \dot{N}₁\dot{N}₂ corresponding to sub-array j for j=0, . . . , N−1. Then column j of \tilde{V} includes zero elements except for indices that belong to Sⱼ where we have

$${[ \tilde{V} ]}_{{s}_{i}^{( j )} , j} = {g}_{i}^{( j )} , \qquad i = 0 , 1 , … , {\dot{N}}_{1} {\dot{N}}_{2} - 1 , \qquad j = 0 , … , {\overline{N}}_{1} {\overline{N}}_{2} - 1 .$$

In a first implementations the sub-array dimensions are set to (\dot{N}₁, \dot{N}₂)=(Ñ₁, Ñ₂), e.g. the sub-array includes the entire array and each LC j is taken over all ports, with different coefficients for each j. In a second implementation the sub-array dimensions are set such that \dot{N}₁<Ñ₁ and/or \dot{N}₂<Ñ₂. In a first example, the sub-arrays are formed as rectangular sub-arrays of neighboring ports. In this case, the indices corresponding to the antenna ports of sub-array j are given as

$${s}_{i}^{( j )} {=}^{Δ} {\tilde{N}}_{2} ( ⌊ \frac{j}{{\overline{N}}_{2}} ⌋ {\dot{N}}_{1} + ⌊ \frac{i}{{\dot{N}}_{2}} ⌋ ) + mod ( j , {\overline{N}}_{2} ) {\dot{N}}_{2} + mod ( i , {\dot{N}}_{2} ) , i = 0 , 1 , … , {\dot{N}}_{1} {\dot{N}}_{2} - 1 .$$

In a second example, the sub-arrays are formed by ports whose indices belong to 2D rectangular lattices. In this case, the indices corresponding to the antenna ports of sub-array j are given as

$${s}_{i}^{( j )} {=}^{Δ} {\tilde{N}}_{2} ( ⌊ \frac{i}{{\overline{N}}_{2}} ⌋ {\dot{N}}_{1} + ⌊ \frac{i}{{\dot{N}}_{2}} ⌋ ) + mod ( j , {\overline{N}}_{2} ) {\dot{N}}_{2} + mod ( i , {\dot{N}}_{2} ) , i = 0 , 1 , … , {\dot{N}}_{1} {\dot{N}}_{2} - 1 .$$

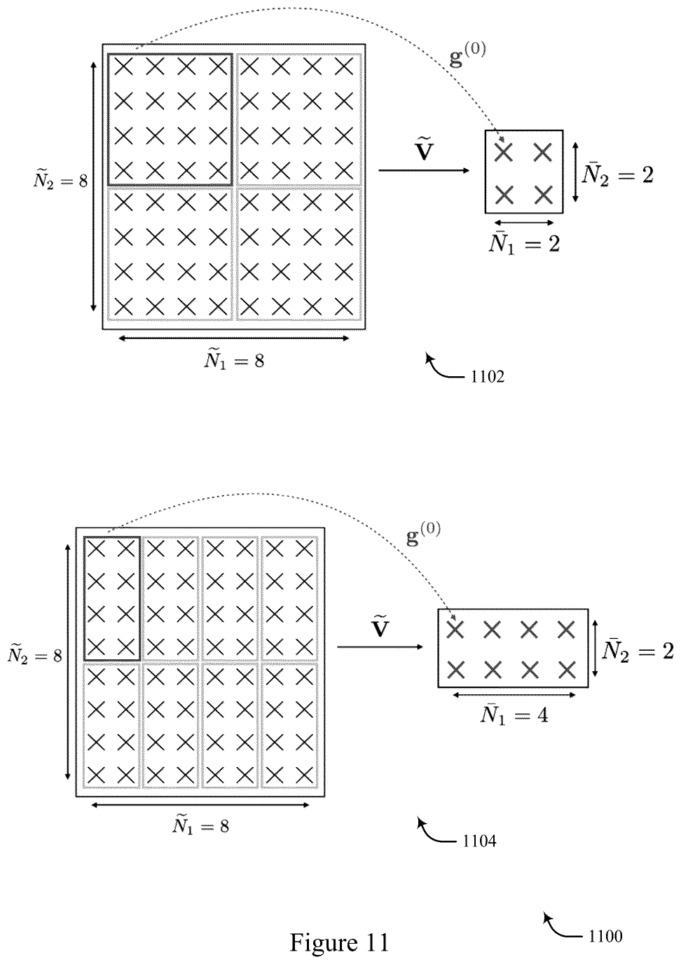

FIG. 11 illustrates an implementation 1100 in accordance with aspects of the present disclosure. The implementation 1100, for instance, includes a first portion 1102 and a second portion 1104 that illustrate two respective examples of action of the first stage of the proposed precoder \tilde{V} according to Design 2 with rectangular formation of neighboring ports as sub-arrays. The portions 1102, 1104, for example, illustrate two examples of the action of \tilde{V} according to this formation of sub-arrays, corresponding to rectangular sub-arrays of different dimensions ((\dot{N}₁, \dot{N}₂)=(4,4) in the portion 1102 and (\dot{N}₁, \dot{N}₂)=(2,4) in the portion 1104. In both portions 1102, 1104, the array dimension is (Ñ₁, Ñ₂)=(8, 8). In the portion 1102 the dimension of the virtual array is (N̅₁, N̅₂)=(2, 2) and in the portion 1104 the dimension of the virtual array is (N̅₁, N̅₂)=(4, 2).

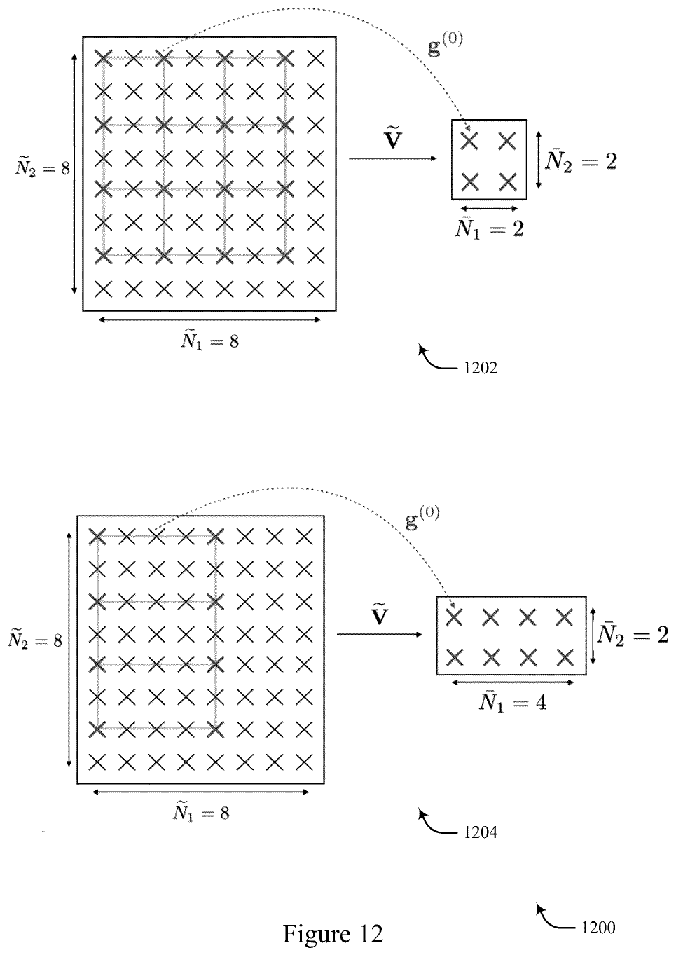

FIG. 12 illustrates an implementation 1200 in accordance with aspects of the present disclosure. The implementation 1200, for instance, includes a first portion 1202 and a second portion 1204 that illustrate two respective examples of action of the first stage of the proposed precoder V according to Design 2 with “lattice” formation of ports as sub-arrays. In both of the portions 1202, 1204, the array dimension is (N₁, N₂)=(8, 8). In the portion 1202 the dimension of the virtual array is (N₁, N₂)=(2, 2) and in the portion 1204 the dimension of the virtual array is (N₁, N₂)=(4, 2). Only one of lattices/sub-arrays is highlighted to avoid cluttering the figure. The other lattices/sub-arrays are formed by horizontal and vertical shifts of this lattice/sub-array.

Regarding selection of port combining coefficients, the coefficients g^{(j)} can be implemented differently for different sub-arrays and layers or be common among them. In a first example, the vector g^{(j)} is common for all sub-arrays, e.g., g⁽⁰⁾=g⁽¹⁾= . . . =g^{(N̅-1)} [symbol] g. In a second example, the vector g^{(j)} is dependent on a corresponding layer index 1, e.g., the vector g^{(j)} is further associated with a layer index as g^{(j,l)}, and generally it could be the case that g^{(j,l)}≠g^{(j,l′)} for l≠l′. In a third example, the vector g^{(j)} is dependent on both a sub-band and a layer index l, e.g., the vector g^{(j)} is further associated with a layer index as g^{(j,l,n)}, and generally it could be the case that g^{(j,l,n)}≠g^{(j,l′,n′)} for (l, n)≠(l′, n′). For ease of exposition, we assume g^{(j)} is common for all sub-arrays and layers, and hence we denote it by g.

In implementations the vector g is drawn from a codebook [symbol] including | [symbol] | vectors as codewords. In a first example, the codebook G includes vectors including phase-shift coefficients, defined as

$$= \{ [ \begin{matrix}1 & {e}^{j {ϕ}_{1}} & … & {{e}^{j {ϕ}_{{\dot{N}}_{1} {\dot{N}}_{2} - 1}} ]}^{T} ,\end{matrix} {ϕ}_{i} ∈ Φ , i = 0 , … , {\dot{N}}_{1} {\dot{N}}_{2} - 1 \} ,$$

where Φ is a set of phase values.

In a second example, the set of phase values in the first example is given as

$$Φ = \{ 0 , \frac{π}{2} , π , \frac{3 π}{2} \} .$$

In a third example, a codeword in [symbol] is parametrized by a value ϕ₁, . . . , ϕ_{\dot{N}}_{₁}_{N}_{₂}₋₁. In a fourth example, the codeword is indicated via ┌log₂|Φ|^{\dot{N}}^{₁}^{\dot{N}}^{₂}⁻¹┐ bits. In a fifth example, the indication of the codeword is reported in CSI Part 2 of the CSI report. In a sixth example, the vector g is drawn from a codebook G corresponding to a set of column vectors of a two-dimensional DFT matrix in the \dot{N}₁\dot{N}₂-dimensional space, where the codebook includes column vectors v_{1,m}, as follows:

$${=}^{Δ} \{ {ν}_{l , m} , l = {O}_{1} {n}_{1} + {q}_{1} , 0 \leq {n}_{1} < {\dot{N}}_{1} , 0 \leq {q}_{1} < {O}_{1} , m = {0}_{2} {n}_{2} + {q}_{2} , 0 \leq {n}_{2} < {\dot{N}}_{2} , 0 \leq {q}_{2} < {O}_{2} \} ,$$

$$where$$

$${u}_{m} {=}^{Δ} [ \begin{matrix}1 & {e}^{j \frac{2 π m}{{O}_{2} {\dot{N}}_{2}}} & … & {e}^{j \frac{2 πm ( {\dot{N}}_{2} - 1 )}{{O}_{2} {\dot{N}}_{2}}} ]\end{matrix} ,$$

$${v}_{l , m} = {[ \begin{matrix}{u}_{m} & {e}^{j \frac{2 π m}{{O}_{2} {\dot{N}}_{2}}} {u}_{m} & … & {e}^{j \frac{2 πl ( {\dot{N}}_{1} - 1 )}{{O}_{1} {N}_{1}}} {u}_{m}\end{matrix} ]}^{T} .$$

The parameters O₁, O₂ are “oversampling factors”, assumed for the 2D DFT matrix. Hence, to report a codeword g∈ [symbol] , the UE has to report the indices parameters (l, m, q₁, q₂). In a seventh example, a codeword in the codebook is parametrized by a set of indices (l, m, q₁, q₂). In an eighth example, the codeword is indicated via ┌log₂ \dot{N}₁·\dot{N}₂┐+┌log₂ O₁·O₂┐ bits. In a ninth example, the indication of the codeword is reported in CSI Part 2 of the CSI report.

In summary, to determine V according to Design 2, two components are to be reported by the UE: (1) the first component corresponds to the configuration of the virtual array, e.g. the dimensions (N̅₁, N̅₂), which determines the sub-arrays and their corresponding indices. (2) The second component corresponds to the reporting of the vector of coefficients g from a codebook [symbol] .

In the following discussion we propose an enhanced Type-I codebook design, e.g., eType-1 codebook design. Different implementations are described below. According to various scenarios a combination of one or more implementations is not precluded. We denote the transmit antenna array dimension by (Ñ₁, Ñ₂).

In a first implementation, a precoding matrix corresponding to layer l takes on a form:

$$\begin{matrix}{W}_{l} = {W}_{1} \times {W}_{2 , l} , & {W}_{1}\end{matrix} = [ \begin{matrix}B & 0 \\ 0 & B\end{matrix} ] ,$$

where L≥1 corresponds to the number of columns of matrix B, e.g., a number of DFT column vectors of B can exceed one.

In a second implementation, a number of DFT column vectors of B is proportional to a reported number of layers ν. In a first example, L=ν, e.g., a one-to-one mapping between beams and layers. A reporting of the beams can include

$$⌈ {log}_{2} ( \begin{matrix}{\tilde{N}}_{1} {\tilde{N}}_{2} \\ L\end{matrix} ) ⌉ + ⌈ {log}_{2} L ! ⌉$$

bits, where

$$( \begin{matrix}a \\ b\end{matrix} )$$

is an n-choose-k operator, and c! corresponds to a factorial function. Therefore, a value of L is UE selected and inferred from a reported rank in CSI Part 1 of the CSI report. In a second example,

$$L = ⌈ \frac{v}{2} ⌉ ,$$

e.g., a one-to-two mapping between beams and layers. An example of the correspondence of layer pairs with beams for ν>2 is as shown in Table 12, as follows:

TABLE 12
Beam to layer index mapping under Example 2

| Layer index | Beam index |
|---|---|
| {1, 2} | i₁ |
| {3, 4} | i₂ |
| {5, 6} | i₃ |
| {7, 8} | i₄ |

In a third example, the correspondence of layer pairs with beams, as shown in Table 13, as follows:

TABLE 13
Beam to layer index mapping under Example 3

| Layer index | Beam index |
|---|---|
| {1, 4} | i₁ |
| {2, 3} | i₂ |
| {5, 6} | i₃ |
| {7, 8} | i₄ |

In a fourth example, up to 4 layers are associated with a same beam. An example of the correspondence of layers with beams for ν>2 is shown in Table 14, as follows:

TABLE 14
Beam to layer index mapping under Example 4

| Layer index | Beam index |
|---|---|
| {1, 4, 5, 8} | i₁ |
| {2, 3, 6, 7} | i₂ |

In a third implementation, a two-stage precoding design is considered where the precoding matrix corresponding to layer l and sub-band n takes on a form:

$$\begin{matrix}{W}_{l , n} = {V}_{l , n} \times {W}_{1} \times {W}_{2 , l , n} , & {W}_{1} = [ \begin{matrix}B & 0 \\ 0 & B\end{matrix} ]\end{matrix} ,$$

where V_{l,n} corresponding to a first stage of the two-stage PMI, is a complex-valued matrix of dimension 2Ñ₁Ñ₂×2N̅ where we have defined N̅≙N̅₁N̅₂, N̅₁≤Ñ₁ and N̅₂≤Ñ₂, and W_{2,l,n} is a vector of dimension 2L.

In a first example, a value of N̅ includes at least one of {2, 4, 6, 8, 12, 16}, where N̅ is an intermediate “reduced” dimension, where N̅<Ñ₁Ñ₂. In a second example, a value of each of N̅₁, N̅₂ includes at least one of {2, 4, 6, 8, 12, 16}, where N̅₁≤Ñ₁, N̅₂≤Ñ₂. In a third example, the values of N̅₁, N̅₂ correspond to the values N₁, N₂, respectively, in legacy PMI codebooks, e.g., N̅₁=N₁, N̅₂=N₂, and the value of N̅ corresponds to the number of CSI-RS ports, P_{CSI-RS}, e.g., N̅→P_{CSI-RS}/2. In a fourth example, 2Ñ₁Ñ₂>32. A maximum value of 2Ñ₁Ñ₂ can be up to 128.

In a fifth example, the matrix V_{l,n} is sub-band specific and layer-specific, e.g. a value of the first-stage PMI is distinctly chosen for each sub-band n and layer l. In a sixth example, the matrix V_{1,n} is sub-band specific but common among all layers, e.g. V_{l,n}=V_{l′,n} for some n and all l≠1′. In a seventh example, the matrix V_{l,n} is layer specific but common among all sub-bands, e.g. V_{l,n′}=V_{l,n} for some l and all n≠n′.

Next we discuss two designs for the first stage of the precoder, e.g., the matrix V_{l,n}. Although the selection can be independent for each layer and sub-band, we drop the sub-band indices n in the sequel for simplicity and discuss the design of matrix V₁ for each layer. To generalize, the following does not preclude the design of sub-band dependent first stage matrix V₁.

Assuming dual-polarized antennas, we represent V₁ as a block-diagonal matrix,

$${V}_{l} = [ \begin{matrix}{\tilde{V}}_{l} & 0 \\ 0 & {\tilde{V}}_{l}\end{matrix} ] ,$$

where \tilde{V}ₗ is an Ñ₁Ñ₂×N̅₁N̅₂ matrix.

In a fourth implementation, \tilde{V}ₗ is a “selection matrix” that selects the CSI over a subset of ports of a size less than the total number of ports 2Ñ₁Ñ₂. Define G^{(l)}={k₀^{(l)}, . . . , k_{N̅-1}^{(l)}}⊆{0,1, . . . , Ñ₁Ñ₂−1} as a subset of port indices of size N̅≙N̅₁N̅₂. We also define

$${S}_{{G}^{( l )}} {=}^{Δ} [ {e}_{{k}_{o}^{( l )}}^{{\tilde{N}}_{1} {\tilde{N}}_{2}} , … , {e}_{{k}_{\overline{N} - 1}^{( l )}}^{{\tilde{N}}_{1} {\tilde{N}}_{2}} ]$$

as a selection matrix including standard unit vectors corresponding to the subset G^{(l)}, where eₓ^{y} is the standard unit vector of dimension y, which includes elements all equal to 0 except for an element in location x equal to 1. Then, the first stage of the precoder is given, for layer l as

\tilde{V}ₗ=S_{G}_{^{(l)}},

for an arbitrary subset of indices G^{(l)}.

In a first example, for a total number of layers ν=1 and ν=2, the intermediate dimensions N̅₁ and N̅₂ are set such that N̅₁N̅₂=Ñ₁Ñ₂ and G^{(l)}={0,1, . . . , Ñ₁Ñ₂−1} for l=1,2 and \tilde{V}₁=\tilde{V}₂=I, where I is the identity matrix of dimension Ñ₁Ñ₂, e.g. the first stage of the precoder choses the CSI over all ports.

In a second example, for a total number of layers ν=3 and ν=4, the ports are partitioned in two Kₚ=2 non-overlapping groups. Denote these two groups by G₁⊂{0,1, . . . , Ñ₁Ñ₂−1} and G₂=G̅ (the complement of G₁). Then the first stage of the precoder is given as, for example,

\tilde{V}ₗ=S_{G}_{₁} for l=1, 3,

and

\tilde{V}ₗ=S_{G}_{₂} for l=2, 4.

In a third example, the two port groups in the second example are given as

$${G}_{1} = \{ 0 , … , \frac{{\tilde{N}}_{1} {\tilde{N}}_{2}}{2} - 1 \} and {G}_{2} = \{ \frac{{\tilde{N}}_{1} {\tilde{N}}_{2}}{2} , … , {\tilde{N}}_{1} {\tilde{N}}_{2} - 1 \} .$$

In a fourth example, for a total number of layers ν=5 and ν=6, the ports are partitioned in two Kₚ=3 non-overlapping groups. Denote these three groups by G₁, G₂, G₃ ⊂{0,1, . . . , Ñ₁Ñ₂−1}. Then the first stage of the precoder is given as, for example,

\tilde{V}ₗ=S_{G}_{₁} for l=1, 4,

and

\tilde{V}ₗ=S_{G}_{₂} for l=2, 5,

and

\tilde{V}ₗ=S_{G}_{₃} for l=3, 6.

In a fifth example, the three port groups in the fourth example are given as

$${G}_{1} = \{ 0 , … , ⌈ \frac{{\tilde{N}}_{1} {\tilde{N}}_{2}}{3} ⌉ - 1 \} , {G}_{2} = \{ ⌈ \frac{{\tilde{N}}_{1} {\tilde{N}}_{2}}{3} ⌉ , … , ⌈ 2 \frac{{\tilde{N}}_{1} {\tilde{N}}_{2}}{3} ⌉ - 1 \} and$$

$${G}_{3} = \{ ⌈ 2 \frac{{\tilde{N}}_{1} {\tilde{N}}_{2}}{3} ⌉ , … , {\tilde{N}}_{1} {\tilde{N}}_{2} - 1 \} .$$

In a sixth example, for a total number of layers ν=7 and ν=8, the ports are partitioned in Kₚ=4 non-overlapping groups. Denote these four groups by G₁, G₂, G₃, G₄ ⊂{0,1, . . . , Ñ₁Ñ₂−1}. Then the first stage of the precoder is given as, for example,

\tilde{V}ₗ=S_{G}_{₁} for l=1, 5,

and

\tilde{V}ₗ=S_{G}_{₂} for l=2, 6,

and

Vₗ=S_{G}_{₃} for l=3, 7,

and

Vₗ=S_{G}_{₄} for l=4, 8.

In a seventh example, the four port groups in the sixth example are given as

$${G}_{1} = \{ 0 , … , ⌈ \frac{{\tilde{N}}_{1} {\tilde{N}}_{2}}{4} ⌉ - 1 \} , {G}_{2} = \{ ⌈ \frac{{\tilde{N}}_{1} {\tilde{N}}_{2}}{4} ⌉ , … , ⌈ \frac{{\tilde{N}}_{1} {\tilde{N}}_{2}}{2} ⌉ - 1 \} and$$

$${G}_{3} = \{ ⌈ \frac{{\tilde{N}}_{1} {\tilde{N}}_{2}}{2} ⌉ , … , ⌈ 3 \frac{{\tilde{N}}_{1} {\tilde{N}}_{2}}{4} ⌉ - 1 \} , {G}_{4} = \{ ⌈ 3 \frac{{\tilde{N}}_{1} {\tilde{N}}_{2}}{4} ⌉ , … , {\tilde{N}}_{1} {\tilde{N}}_{2} - 1 \} .$$

In a fifth implementation, the set of CSI-RS ports are partitioned to multiple port groups, and the set of layers whose size is determined by a rank indicator are partitioned to a plurality of subsets of layers, where each subset of layers is associated with at least one port group. In a first example, the set of CSI-RS ports are partitioned based on an associated CSI-RS resource, e.g., a number of port groups is equal to a number of CSI-RS resources whose CSI-RS ports are associated with the set of CSI-RS ports. In a second example, a number of CSI-RS ports in each port group is the same.

In a third example, a number of subsets of layers is one for a rank indicator value of two or less, corresponding to the set of layers, where the subset of layers is associated with the set of CSI-RS ports. In a fourth example, a number of subsets of layers is two for a rank indicator value greater than two, and where a mapping between the subsets of layers and the port groups is similar to the previous tables in this section. In a fifth example, a number of subsets of layers is up to four for a rank indicator value greater than four, and where a mapping between the subsets of layers and the port groups is similar to the previous tables above.

The following discusses compressed PMI subband reporting. For instance, for PMI configured with PMI format indicator set to ‘subband’, we propose reporting the PMI for only a subset of the sub-bands, in order to reduce the CSI feedback overhead in the frequency domain. In other words, we exploit the extra degrees of spatial freedom by increasing the number of antennas, to reduce the CSI feedback overhead in frequency without incurring a significant reduction in precoding resolution. Let δₗ∈[0,1] denote a frequency-domain CSI compression ratio, defined as

$${δ}_{l} {=}^{Δ} \frac{{N}_{r e p}^{( l )}}{{N}_{3}} ,$$

where N₃ is the number of sub-bands and Nᵣₑₚ^{(l)}≤N₃ is the number of sub-bands over which CSI is reported, per layer l.

In a first implementation, the sub-band component of the CSI e.g. the matrix W_{2,l,n} is reported per layer l over a subset of sub-bands [symbol] ₗ⊆{1, . . . , N₃} where the size of [symbol] ₗ is equal to | [symbol] ₗ|=└δₗN₃┘, including a δₗ fraction of the sub-band indices. Otherwise stated, the UE reports an indication of the following for PMI sub-band reporting:

W_{2,l,n}, n∈ [symbol] ₗ,

for each layer l.

In a first example, the fraction δₗ is layer common, e.g., δ₁=δ₂= . . . =δ_{ν}=δ where ν is the transmission rank. In a second example, the fraction δₗ is chosen from a set of values,

$$e . g . , [ \frac{1}{8} , \frac{1}{4} , \frac{1}{2} , \frac{3}{4} , 1 ] .$$

In a third example, the fraction S is layer common, is set to δ=½ and the set of indices [symbol] ₗ is given as

$${𝕊}_{l} = \{ 2 n + 1 \vert n = 0 , 1 , ⌊ \frac{{N}_{3}}{2} ⌋ - 1 \} , if l is even and ,$$

$${𝕊}_{l} = \{ 2 n \vert n = 0 , 1 , ⌊ \frac{{N}_{3}}{2} ⌋ - 1 \} , if l is odd .$$

For instance, layers with even indices are associated with odd indexed sub-bands, and layers with odd indices are associated with even indexed sub-bands. Alternatively, layers with odd indices are associated with odd indexed sub-bands, and layers with even indices are associated with even indexed sub-bands.

In a fourth example, the fraction δ is layer common, is set to δ=¼ and the set of indices [symbol] ₗ is given as

$${𝕊}_{l} = \{ 4 n + 2 \vert n = 0 , 1 , ⌊ \frac{{N}_{3}}{4} ⌋ - 1 \} , if l is even and ,$$

$${𝕊}_{l} = \{ 4 n \vert n = 0 , 1 , ⌊ \frac{{N}_{3}}{4} ⌋ - 1 \} , if l is odd .$$

In a fifth example, the fraction δ is layer common, is set to δ=¼ and the set of indices [symbol] ₗ is given as

$${𝕊}_{l} = \{ 4 n \vert n = 0 , 1 , ⌊ \frac{{N}_{3}}{4} ⌋ - 1 \} , if l = 1 , 5 ,$$

$${𝕊}_{l} = \{ 4 n + 1 \vert n = 0 , 1 , ⌊ \frac{{N}_{3}}{4} ⌋ - 1 \} , if l = 2 , 6 ,$$

$${𝕊}_{l} = \{ 4 n + 2 \vert n = 0 , 1 , ⌊ \frac{{N}_{3}}{4} ⌋ - 1 \} , if l = 3 , 7 ,$$

$${𝕊}_{l} = \{ 4 n + 3 \vert n = 0 , 1 , ⌊ \frac{{N}_{3}}{4} ⌋ - 1 \} , if l = 4 , 8 .$$

In a sixth example, the fraction δ is layer common, is set to δ=⅛ and the set of indices [symbol] ₁ is given as

$${𝕊}_{l} = \{ 8 n + 4 \vert n = 0 , 1 , ⌊ \frac{{N}_{3}}{8} ⌋ - 1 \} , if l is even and ,$$

$${𝕊}_{l} = \{ 8 n \vert n = 0 , 1 , ⌊ \frac{{N}_{3}}{8} ⌋ - 1 \} , if l is odd .$$

In a seventh example, the fraction S is layer common, is set to δ=⅛ and the set of indices [symbol] ₗ is given as

$${𝕊}_{l} = \{ 8 n \vert n = 0 , 1 , ⌊ \frac{{N}_{3}}{8} ⌋ - 1 \} , if l = 1 ,$$

$${𝕊}_{l} = \{ 8 n + 1 \vert n = 0 , 1 , ⌊ \frac{{N}_{3}}{8} ⌋ - 1 \} , if l = 2 ,$$

$${𝕊}_{l} = \{ 8 n + 2 \vert n = 0 , 1 , ⌊ \frac{{N}_{3}}{8} ⌋ - 1 \} , if l = 3 ,$$

$${𝕊}_{l} = \{ 8 n + 3 \vert n = 0 , 1 , ⌊ \frac{{N}_{3}}{8} ⌋ - 1 \} , if l = 4 ,$$

$${𝕊}_{l} = \{ 8 n + 4 \vert n = 0 , 1 , ⌊ \frac{{N}_{3}}{8} ⌋ - 1 \} , if l = 5 ,$$

$${𝕊}_{l} = \{ 8 n + 5 \vert n = 0 , 1 , ⌊ \frac{{N}_{3}}{8} ⌋ - 1 \} , if l = 6 ,$$

$${𝕊}_{l} = \{ 8 n + 6 \vert n = 0 , 1 , ⌊ \frac{{N}_{3}}{8} ⌋ - 1 \} , if l = 7 ,$$

$${𝕊}_{l} = \{ 8 n + 7 \vert n = 0 , 1 , ⌊ \frac{{N}_{3}}{8} ⌋ - 1 \} , if l = 8 .$$

In an eighth example, compressed PMI sub-band reporting is supported only if a total number of CSI-RS ports is larger than 32.

Implementations also include compressed CQI subband reporting. For instance, for CQI configured with CQI format indicator set to ‘subband’, we propose reporting the CQI for only a subset of the subbands, in order to reduce the CSI feedback overhead in the frequency domain. In other words, we exploit the extra degrees of spatial freedom by increasing the number of antennas, to reduce the CSI feedback overhead in frequency without incurring a significant reduction in precoding resolution. Let γ_{c}∈[0,1] denote a frequency-domain CSI compression ratio, defined as

$${γ}_{c} {=}^{Δ} \frac{{\dot{N}}_{r e p}^{( l )}}{{N}_{3}} ,$$

where N₃ is the number of sub-bands and \dot{N}ᵣₑₚ^{(l)}≤N₃ is the number of sub-bands over which CQI is reported, per codeword index c, where c∈{1,2}.

In a first example, the fraction γ_{c} is codeword common, e.g., the same fraction is applied to the up to two CQIs associated with the up to two codewords. In a second example, the fraction γ_{c} is chosen from a set of values,

$$e . g . , [ \frac{1}{8} , \frac{1}{4} , \frac{1}{2} , \frac{3}{4} , 1 ] .$$

In a third example, the codeword common fraction γ is set to ½, where a first of the up to two codewords is associated with even indexed subbands, and a second of the up to two codewords is associated with odd indexed sub-bands. Alternatively, the first of the up to two codewords is associated with odd indexed sub-bands, and a second of the up to two codewords is associated with even indexed sub-bands. In a fourth example, compressed CQI sub-band reporting is supported only if a total number of CSI-RS ports is larger than 32.

In another implementation, a number of PMI sub-bands per CQI sub-bands can be configured to a value smaller than one, e.g., ½, if a total number of CSI-RS ports is larger than 32.

Implementations are also described for dual codebook mode and may be combined in various ways. In a first implementation, two codebook modes are supported. A first codebook mode of the two codebook (CB) modes is an extension of Rel-16 eType-II CB, or Rel-18 eType-II CB, such that N>=32. A second codebook mode of the two codebook modes correspond to the enhanced precoding with large ports. A selection of one of the two codebook modes is based on at least one of the following:
a) Higher-layer configuration by the network, where the network signals the selected codebook mode to the UE as part of the CSI reporting setting, CSI-ReportConfig. Alternatively, the higher layer configuration is included in the corresponding codebook configuration.
b) UE-selected, where the UE signals the selected codebook mode to the network as part of the CSI report, where the codebook mode is fed back in CSI Part 1 of the CSI report.

Implementations are also described for CSI-RS port grouping and may be combined in various ways. In a first implementation, the total number of CSI-RS ports, P_{CSI-RS}, is equivalent to 2Ñ₁Ñ₂, e.g., P_{CSI-RS}=2Ñ₁Ñ₂. In a first example, the total number of CSI-RS ports, P_{CSI-RS}, corresponds to a total NZP CSI-RS ports associated with one NZP CSI-RS resource for channel measurement, where the NZP CSI-RS resource for channel measurement is configured within the CSI Reporting Setting including indication of the enhanced codebook design.

In a second example, the total number of CSI-RS ports, P_{CSI-RS}, corresponds to a summation of NZP CSI-RS ports associated with a plurality of NZP CSI-RS resources for channel measurement, e.g., P_{CSI-RS} [symbol] K. P_{CSI-RS,resource}, where P_{CSI-Rs,resource} is a number of NZP CSI-RS ports per CSI-RS resource, and K is a number of CSI-RS resources of an NZP CSI-RS resource set configured within the CSI Reporting Setting including indication of the enhanced codebook design.

In a third example, a maximum value of P_{CSI-RS} is 128 and a maximum value of P_{CSI-RS,resource} is 32. In a fourth example, a maximum number of CSI-RS ports per CSI-RS resource corresponding to a CSI reporting setting associated with the enhanced codebook design is 64, where the number of code division multiplexing (CDM) groups corresponding to the CSI-RS ports is up to 4.

In a second implementation, if a UE is configured with multiple, e.g., N, NZP CSI-RS resources for channel measurement, the NZP CSI-RS ports of the multiple NZP CSI-RS resources are reindexed to a unified set of CSI Ports including the total number of CSI-RS ports, where each NZP CSI-RS resource is associated with K CSI-RS ports.

In a first example, a port index k of an NZP CSI-RS resource n, is denoted by pₖ⁽ⁿ⁾, are reindexed to a unified port index pⱼ*, where the reindexing is done in an alternating fashion, e.g.,

$${p}^{*} = [ \begin{matrix}{p}_{0}^{( 1 )} & {p}_{0}^{( 2 )} & … & {p}_{0}^{( N )} & {p}_{1}^{( 1 )} & … & {p}_{1}^{( N )} & {p}_{2}^{( 1 )} & … & {p}_{K - 2}^{( N )} & {p}_{K - 1}^{( 1 )} & … & {p}_{K - 1}^{( N )}\end{matrix} ]$$

In a second example, a port index k of an NZP CSI-RS resource n, is denoted by pₖ⁽ⁿ⁾, are reindexed to a unified port index pⱼ*, where the reindexing is done in a concatenated fashion, e.g.,

$${p}^{*} = [ \begin{matrix}{p}_{0}^{( 1 )} & {p}_{1}^{( 1 )} & … & {p}_{K - 1}^{( 1 )} & {p}_{0}^{( 2 )} & … & {p}_{K - 1}^{( 2 )} & {p}_{0}^{( 3 )} & … & {p}_{K - 1}^{( N - 1 )} & {p}_{0}^{( N )} & … & {p}_{K - 1}^{( N )}\end{matrix} ]$$

In a third example, a port index k of an NZP CSI-RS resource n, is denoted by pₖ⁽ⁿ⁾, are reindexed to a unified port index pⱼ*, where the reindexing is done in a concatenated fashion per polarization, e.g.,

$${p}^{*} = [ {p}_{0}^{( 1 )} … {p}_{\frac{K}{2} - 1}^{( 1 )} {p}_{0}^{( 2 )} … {p}_{\frac{K}{2} - 1}^{( 2 )} … {p}_{\frac{K}{2} - 1}^{( N )} {p}_{\frac{K}{2}}^{( 1 )} … {p}_{K - 1}^{( 1 )} {p}_{\frac{K}{2}}^{( 2 )} … {p}_{K - 2}^{( N )} {p}_{K - 1}^{( N )} ]$$

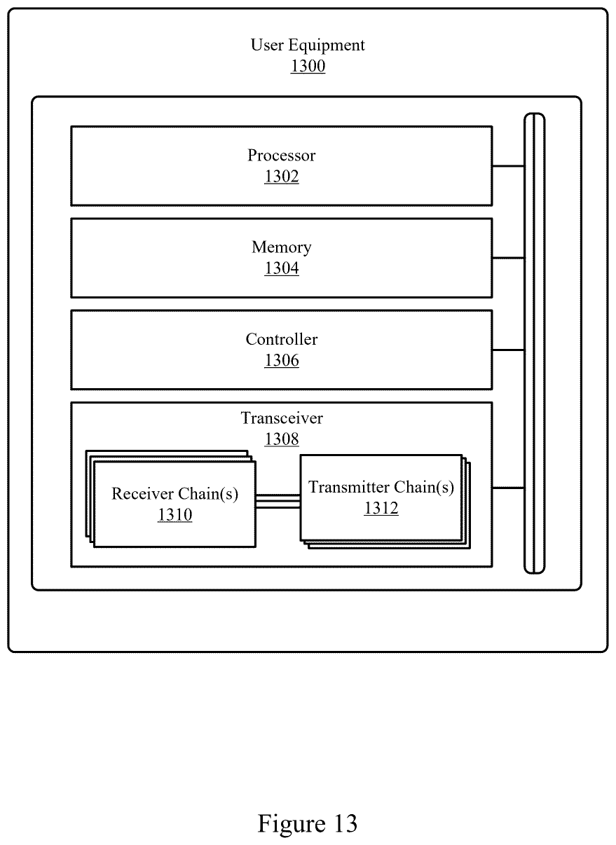

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein.

The UE 1300 may be configured to or operable to support a means for generating a CSI report including a PMI for at least one precoding matrix and a CQI for channel quality: the at least one precoding matrix corresponding to a set of layers with each layer of the set of layers associated with a spatial beam and a size of the set of layers determined by a RI reported by the UE; the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmitting the CSI report including the RI, the PMI, and the CQI to a network entity.

Additionally, the UE 1300 may be configured to support any one or combination of receiving, from the network entity, a configuration signal corresponding to the CSI reporting setting; receiving CSI-RS corresponding to at least one NZP CSI-RS resource including the plurality of CSI-RS ports and based at least in part on the CSI reporting setting; and generating the CSI report based at least in part on the CSI reporting setting and the CSI-RS; reporting a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI.

Additionally, the UE 1300 may be configured to support any one or combination of where a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Additionally, or alternatively, the UE 1300 may support means to generate a CSI report including a PMI for at least one precoding matrix and a CQI for channel quality: the at least one precoding matrix corresponding to a set of layers with each layer of the set of layers associated with a spatial beam and a size of the set of layers determined by a RI reported by the UE; the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmit the CSI report including the RI, the PMI, and the CQI to a network entity.

Additionally, the UE 1300 may be configured to support any one or combination of means to receive, from the network entity, a configuration signal corresponding to the CSI reporting setting; receive CSI-RS corresponding to at least one NZP CSI-RS resource including the plurality of CSI-RS ports and based at least in part on the CSI reporting setting; and generate the CSI report based at least in part on the CSI reporting setting and the CSI-RS; report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports.

Additionally, the UE 1300 may be configured to support any one or combination where a number of groups of the multiple layer groups is based on a value of the RI; a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

The UE 1300 may be configured to or operable to support a means for generating a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmitting the CSI report to a network entity.

Additionally, the UE 1300 may be configured to support any one or combination of receiving, from the network entity, a configuration signal corresponding to a CSI reporting setting; receiving CSI-RSs corresponding to at least one NZP CSI-RS resource including the plurality of CSI-RS ports based at least in part on the CSI reporting setting; and generating the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

Additionally, the UE 1300 may be configured to support any one or combination of where a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

Additionally, the UE 1300 may be configured to support any one or combination of where the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

Additionally, or alternatively, the UE 1300 may support means to generate a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmit the CSI report to a network entity.

Additionally, the UE 1300 may be configured to support any one or combination of means to receive, from the network entity, a configuration signal corresponding to a CSI reporting setting; receive CSI-RSs corresponding to at least one NZP CSI-RS resource including the plurality of CSI-RS ports based at least in part on the CSI reporting setting; and generate the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

Additionally, the UE 1300 may be configured to support any one or combination of where a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

Additionally, the UE 1300 may be configured to support any one or combination of where the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., LNA) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

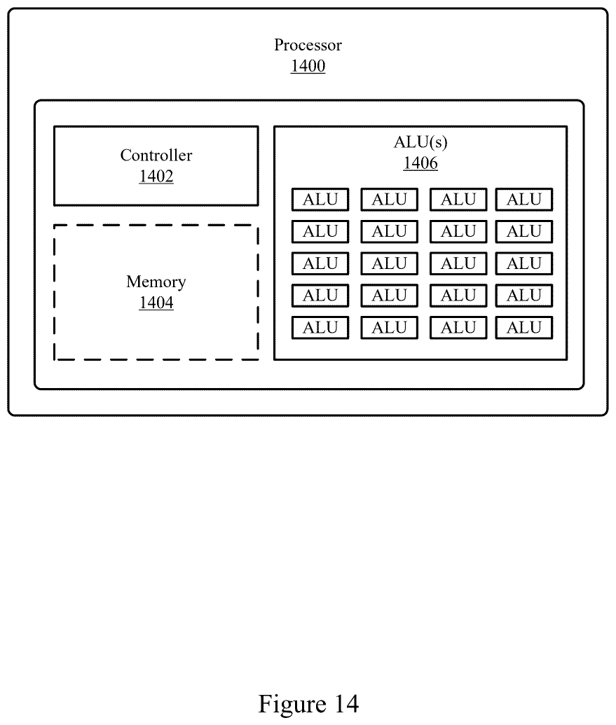

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to generate a CSI report including a PMI for at least one precoding matrix and a CQI for channel quality: the at least one precoding matrix corresponding to a set of layers with each layer of the set of layers associated with a spatial beam and a size of the set of layers determined by a RI reported by a user equipment (UE); the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting; and transmit the CSI report including the RI, the PMI, and the CQI to a network entity.

Additionally, the processor 1400 may be configured to support any one or combination of to receive, from the network entity, a configuration signal corresponding to the CSI reporting setting; receive CSI-RS corresponding to at least one NZP CSI-RS resource including the plurality of CSI-RS ports and based at least in part on the CSI reporting setting; and generate the CSI report based at least in part on the CSI reporting setting and the CSI-RS; report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI.

Additionally, the processor 1400 may be configured to support any one or combination of where a number of groups of the multiple layer groups is no less than half of the value of the RI; the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

The processor 1400 may support wireless communication in accordance with examples as disclosed herein. The processor 1400 may be configured to or operable to generate a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain; and transmit the CSI report to a network entity.

Additionally, the processor 1400 may be configured to support any one or combination of to receive, from the network entity, a configuration signal corresponding to a CSI reporting setting; receive CSI-RSs corresponding to at least one NZP CSI-RS resource including the plurality of CSI-RS ports based at least in part on the CSI reporting setting; and generate the CSI report based at least in part on the CSI reporting setting and the CSI-RSs; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

Additionally, the processor 1400 may be configured to support any one or combination of where a size of a first spatial dimension of the at least two spatial dimensions is equal to an integer multiple of a size of a first spatial sub-dimension of the at least two spatial sub-dimensions, and a size of a second spatial dimension of the at least two spatial dimensions is equal to an integer multiple of a size of a second spatial sub-dimension of the at least two spatial sub-dimensions; the size of the first spatial sub-dimension and the size of the second spatial sub-dimension are configured by the network entity; coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

Additionally, the processor 1400 may be configured to support any one or combination of where the second transformation is based at least in part on one or more of Rel-15 Type-I Single Panel codebook, Rel-16 eType-II codebook, Rel-17 FeType-II codebook, or Rel-18 Type-II Doppler codebook; the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; a selection of at least one codebook mode of the at least two codebook modes is configured by the network entity.

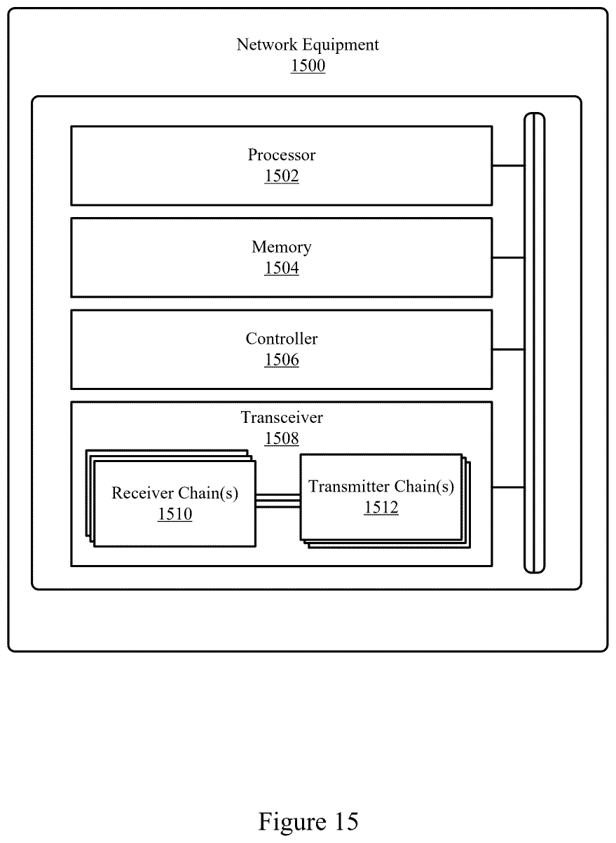

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein.

The NE 1500 may be configured to or operable to support a means for transmitting, to a user equipment (UE), a configuration signal corresponding to a CSI reporting setting, the CSI reporting setting including: an indication to generate a CSI report for at least a subset of CSI-RS ports of a plurality of CSI-RS ports including a PMI for at least one precoding matrix and a CQI for channel quality; the at least one precoding matrix corresponding to a set of layers with each layer of the set of layers associated with a spatial beam and a size of the set of layers determined by a RI reported by the UE; and the PMI and the CQI each being associated with at least one of a wideband format or a subband format, and the subband format corresponding to reporting at least one of the PMI or the CQI for a subset of a set of subbands of a bandwidth part associated with the CSI reporting setting; and receiving, from the UE, a CSI report including the RI, the PMI, and the CQI.

Additionally, the NE 1500 may be configured to support any one or combination of transmitting CSI-RS corresponding to at least one NZP CSI-RS resource including the plurality of CSI-RS ports; receiving, from the UE, a report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI; a number of groups of the multiple layer groups is no less than half of the value of the RI.

Additionally, the NE 1500 may be configured to support any one or combination of where the CQI is associated with the subband format according to a subband configuration; CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

Additionally, or alternatively, the NE 1500 may support means to transmit, to a user equipment (UE), a configuration signal corresponding to a CSI reporting setting, the CSI reporting setting including: an indication to generate a CSI report for at least a subset of CSI-RS ports of a plurality of CSI-RS ports including a PMI for at least one precoding matrix and a CQI for channel quality; the at least one precoding matrix corresponding to a set of layers with each layer of the set of layers associated with a spatial beam and a size of the set of layers determined by a RI reported by the UE; and the PMI and the CQI each being associated with at least one of a wideband format or a subband format, and the subband format corresponding to reporting at least one of the PMI or the CQI for a subset of a set of subbands of a bandwidth part associated with the CSI reporting setting; and receive, from the UE, a CSI report including the RI, the PMI, and the CQI.

Additionally, the NE 1500 may be configured to support any one or combination of to transmit CSI-RS corresponding to at least one NZP CSI-RS resource including the plurality of CSI-RS ports; receive, from the UE, a report a group of spatial beams corresponding to the set of layers; an association of each spatial beam of the group of spatial beams with a layer in the set of layers is indicated in the CSI report; a spatial beam in the group of spatial beams is associated with a subset of the set of layers, the subset of the set of layers being identified by the UE and indicated in the CSI report; the set of layers is further partitioned to multiple layer groups, each layer group including one or more layers; each layer in a same layer group is associated a same subset of the plurality of CSI-RS ports; at least two different layer groups are associated with mutually exclusive subsets of the plurality of CSI-RS ports; a number of groups of the multiple layer groups is based on a value of the RI; a number of groups of the multiple layer groups is no less than half of the value of the RI; the CQI is associated with the subband format according to a subband configuration.

Additionally, the NE 1500 may be configured to support any one or combination of where CQI values associated with only even subbands are included in the CSI report; a value of the RI is larger than four; the CSI report includes at least two values of the CQI, a first value of the at least two values of the CQI is associated with only even subbands, and a second value of the at least two values of the CQI is associated with only odd subbands; the PMI is associated with the subband format; the PMI includes a plurality of PMI values associated with a plurality of PMI subbands; a number of the plurality of PMI subbands is based on at least one of a subband configuration, and a configuration value of a number of PMI subbands per CQI subband; PMI values associated with only even PMI subbands are included in the CSI report; a value of the RI is larger than one; the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

The NE 1500 may be configured to or operable to support a means for transmitting, to a user equipment (UE), a configuration signal corresponding to a CSI reporting setting, the CSI reporting setting including at least one codebook mode and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain.

Additionally, the NE 1500 may be configured to support any one or combination of transmitting, to the UE, CSI-RSs corresponding to at least one NZP CSI-RS resource including the plurality of CSI-RS ports based at least in part on the CSI reporting setting; and receiving, from the UE, a CSI report based at least in part on the CSI reporting setting; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

Additionally, the NE 1500 may be configured to support any one or combination of where a size of a first spatial dimension of the at least two spatial dimensions is equal to an integer multiple of a size of a first spatial sub-dimension of the two spatial sub-dimensions, and a size of a second spatial dimension of the at least two spatial dimensions is equal to an integer multiple of a size of a second spatial sub-dimension of the at least two spatial sub-dimensions; configuring the size of the first spatial sub-dimension and the size of the second spatial sub-dimension; receiving, from the UE, a CSI report based at least in part on the CSI reporting setting, and coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

Additionally, the NE 1500 may be configured to support any one or combination of where the second transformation is based at least in part on one or more of Rel-15 Type-I Single Panel codebook, Rel-16 eType-II codebook, Rel-17 FeType-II codebook, or Rel-18 Type-II Doppler codebook; receiving, from the UE, a CSI report including an indication of a precoding matrix, and where the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; configuring the UE with a selection of at least one codebook mode of the at least two codebook modes.

Additionally, or alternatively, the NE 1500 may support transmit, to a user equipment (UE), a configuration signal corresponding to a CSI reporting setting, the CSI reporting setting including at least one codebook mode and the at least one codebook mode being based at least in part on a codebook type including a set of consecutive transformations including: a first transformation including a reduction of dimensions of a plurality of CSI reference signal (RS) (CSI-RS) ports to a first transform domain; and a second transformation including a first linear transformation of the first transform domain to a second transform domain.

Additionally, the NE 1500 may be configured to support any one or combination of to transmit, to the UE, CSI-RSs corresponding to at least one NZP CSI-RS resource including the plurality of CSI-RS ports based at least in part on the CSI reporting setting; and receive, from the UE, a CSI report based at least in part on the CSI reporting setting; a number of dimensions of the first transform domain is smaller than a number of the plurality of CSI-RS ports, and a number of dimensions of the second transform domain is no larger than the number of dimensions of the first transform domain; the first transformation includes a selection of a subset of CSI-RS ports of the plurality of CSI-RS ports; the first transformation includes a second linear transformation of a domain corresponding to the plurality of CSI-RS ports; the second linear transformation corresponds to a Discrete Fourier-based transformation; the plurality of CSI-RS ports are associated with at least two spatial dimensions, and where dimensions of the first transform domain correspond to at least two spatial sub-dimensions associated with the at least two spatial dimensions.

Additionally, the NE 1500 may be configured to support any one or combination of where a size of a first spatial dimension of the at least two spatial dimensions is equal to an integer multiple of a size of a first spatial sub-dimension of the two spatial sub-dimensions, and a size of a second spatial dimension of the at least two spatial dimensions is equal to an integer multiple of a size of a second spatial sub-dimension of the at least two spatial sub-dimensions; configure the size of the first spatial sub-dimension and the size of the second spatial sub-dimension; receive, from the UE, a CSI report based at least in part on the CSI reporting setting, and coordinates of a reference port associated with the first transform domain are reported in the CSI report, the coordinates corresponding to at least an index pair associated with the at least two spatial dimensions; a first value associated with the index pair includes an integer value that is no larger than a ratio of the size of the first spatial dimension and the size of the first spatial sub-dimension, and a second value associated with the index pair includes an integer value that is no larger than a ratio of the size of the second spatial dimension and the size of the second spatial sub-dimension.

Additionally, the NE 1500 may be configured to support any one or combination of where the second transformation is based at least in part on one or more of Rel-15 Type-I Single Panel codebook, Rel-16 eType-II codebook, Rel-17 FeType-II codebook, or Rel-18 Type-II Doppler codebook; receive, from the UE, a CSI report including an indication of a precoding matrix, and where the precoding matrix corresponds to at least two codebook modes; a second codebook mode of the at least two codebook modes corresponds to a codebook associated with at least one of Rel-15 Type-I Single Panel codebook, Rel-16 eType-II codebook, Rel-17 FeType-II codebook, or Rel-18 Type-II Doppler codebook; a number of the plurality of CSI-RS ports corresponding to the codebook associated with the second codebook mode exceeds 32; configure the UE with a selection of at least one codebook mode of the at least two codebook modes.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a LNA) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

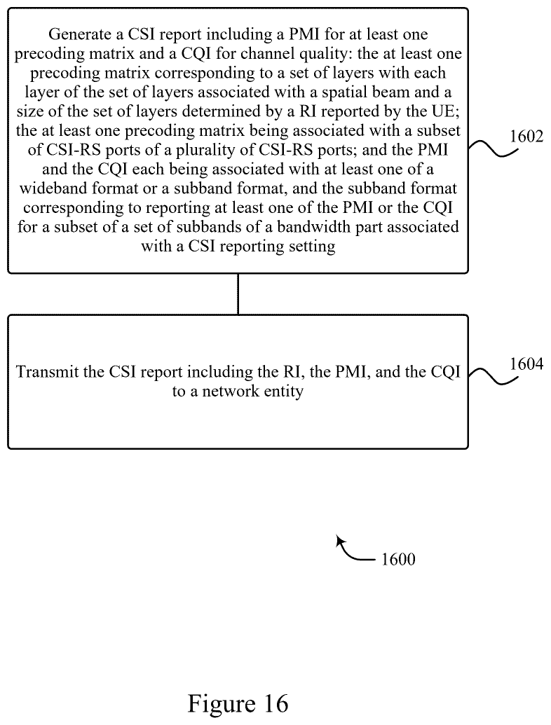

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include generating a CSI report including a PMI for at least one precoding matrix and a CQI for channel quality: the at least one precoding matrix corresponding to a set of layers with each layer of the set of layers associated with a spatial beam and a size of the set of layers determined by a RI reported by the UE; the at least one precoding matrix being associated with a subset of CSI-RS ports of a plurality of CSI-RS ports; and the PMI and the CQI each being associated with at least one of a wideband format or a subband format, and the subband format corresponding to reporting at least one of the PMI or the CQI for a subset of a set of subbands of a bandwidth part associated with a CSI reporting setting. The operations of 1602 may be performed in accordance with examples as described herein. In some implementations, aspects of the operations of 1602 may be performed by a UE as described with reference to FIG. 13.

At 1604, the method may include transmitting the CSI report including the RI, the PMI, and the CQI to a network entity. The operations of 1604 may be performed in accordance with examples as described herein. In some implementations, aspects of the operations of 1604 may be performed by a UE as described with reference to FIG. 13.

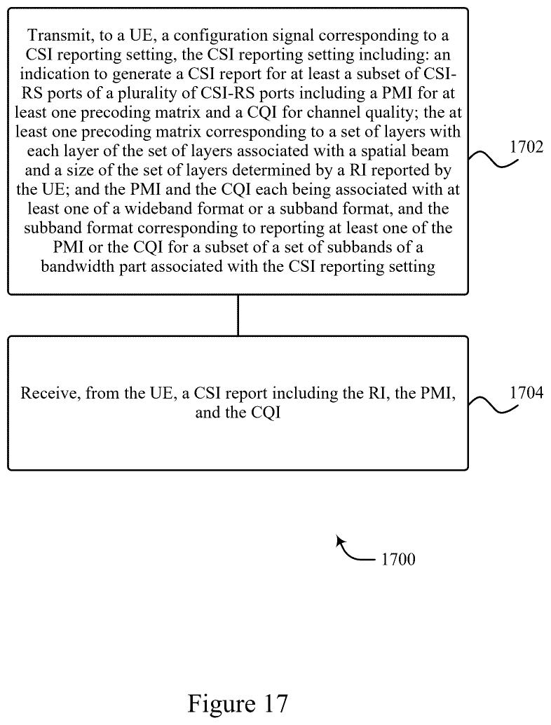

FIG. 17 illustrates a flowchart of a method 1700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include transmitting, to a UE, a configuration signal corresponding to a CSI reporting setting, the CSI reporting setting including: an indication to generate a CSI report for at least a subset of CSI-RS ports of a plurality of CSI-RS ports including a PMI for at least one precoding matrix and a CQI for channel quality; the at least one precoding matrix corresponding to a set of layers with each layer of the set of layers associated with a spatial beam and a size of the set of layers determined by a RI reported by the UE; and the PMI and the CQI each being associated with at least one of a wideband format or a subband format, and the subband format corresponding to reporting at least one of the PMI or the CQI for a subset of a set of subbands of a bandwidth part associated with the CSI reporting setting. The operations of 1702 may be performed in accordance with examples as described herein. In some implementations, aspects of the operations of 1702 may be performed by a NE as described with reference to FIG. 15.

At 1704, the method may include receiving, from the UE, a CSI report including the RI, the PMI, and the CQI. The operations of 1704 may be performed in accordance with examples as described herein. In some implementations, aspects of the operations of 1704 may be performed by a NE as described with reference to FIG. 15.

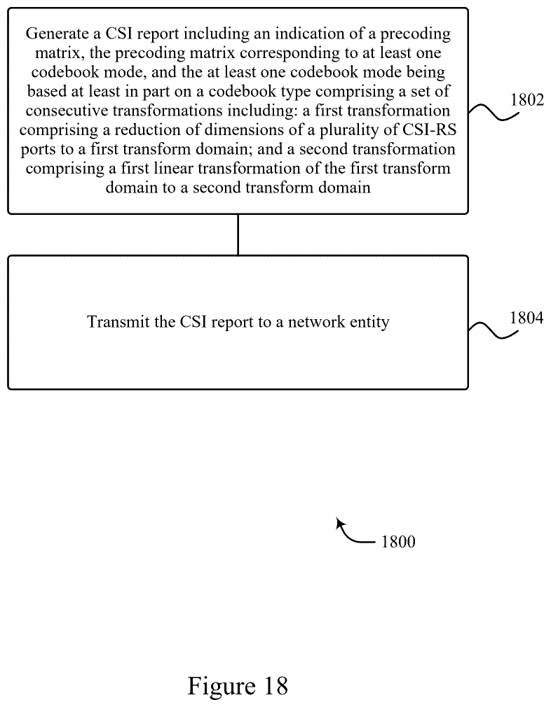

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1802, the method may include generating a CSI report including an indication of a precoding matrix, the precoding matrix corresponding to at least one codebook mode, and the at least one codebook mode being based at least in part on a codebook type including a set of consecutive transformations including: a first transformation including a reduction of dimensions of a plurality of CSI-RS ports to a first transform domain; and a second transformation including a first linear transformation of the first transform domain to a second transform domain. The operations of 1802 may be performed in accordance with examples as described herein. In some implementations, aspects of the operations of 1802 may be performed by a UE as described with reference to FIG. 13.

At 1804, the method may include transmitting the CSI report to a network entity. The operations of 1804 may be performed in accordance with examples as described herein. In some implementations, aspects of the operations of 1804 may be performed by a UE as described with reference to FIG. 13.

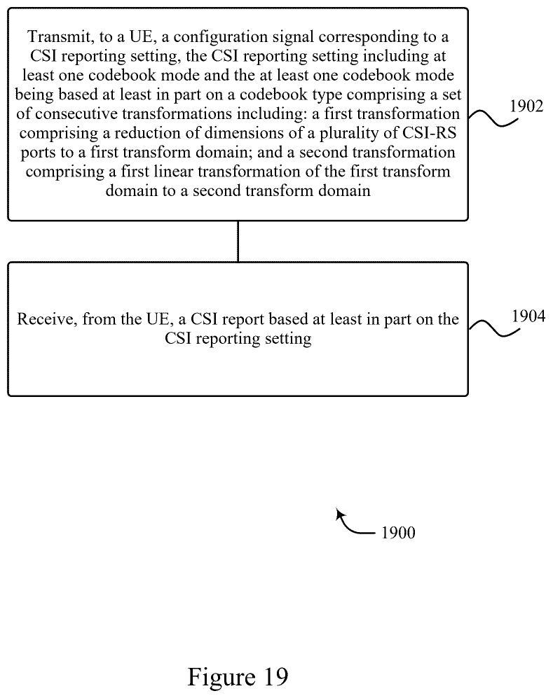

FIG. 19 illustrates a flowchart of a method 1900 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1902, the method may include transmitting, to a UE, a configuration signal corresponding to a CSI reporting setting, the CSI reporting setting including at least one codebook mode and the at least one codebook mode being based at least in part on a codebook type including a set of consecutive transformations including: a first transformation including a reduction of dimensions of a plurality of CSI-RS ports to a first transform domain; and a second transformation including a first linear transformation of the first transform domain to a second transform domain. The operations of 1902 may be performed in accordance with examples as described herein. In some implementations, aspects of the operations of 1902 may be performed by a NE as described with reference to FIG. 15.

At 1904, the method may include receiving, from the UE, a CSI report based at least in part on the CSI reporting setting. The operations of 1904 may be performed in accordance with examples as described herein. In some implementations, aspects of the operations of 1904 may be performed by a NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
generate a channel state information (CSI) report comprising a precoding matrix indicator (PMI) for at least one precoding matrix and a channel quality indicator (CQI) for channel quality:
the at least one precoding matrix corresponding to a set of layers with each layer of the set of layers associated with a spatial beam and a size of the set of layers determined by a rank indicator (RI) reported by the UE;
the at least one precoding matrix being associated with a subset of CSI reference signal (RS)(CSI-RS) ports of a plurality of CSI-RS ports; and
the PMI and the CQI each being associated with at least one of a wideband format or a subband format, and the subband format corresponding to reporting at least one of the PMI or the CQI for a subset of a set of subbands of a bandwidth part associated with a CSI reporting setting; and
transmit the CSI report including the RI, the PMI, and the CQI to a network entity.

2. The UE of claim 1, wherein the at least one processor is configured to cause the UE to:
receive, from the network entity, a configuration signal corresponding to the CSI reporting setting;
receive CSI-RS corresponding to at least one non-zero power (NZP) CSI-RS resource comprising the plurality of CSI-RS ports and based at least in part on the CSI reporting setting; and
generate the CSI report based at least in part on the CSI reporting setting and the CSI-RS.

3. The UE of claim 1, wherein the at least one processor is configured to cause the UE to report a group of spatial beams corresponding to the set of layers, and wherein one or more of:
an association of each spatial beam of the group of spatial beams with a layer in the set of layers is indicated in the CSI report; or
spatial beam in the group of spatial beams is associated with a subset of the set of layers, the subset of the set of layers being identified by the UE and indicated in the CSI report.

4. The UE of claim 1, wherein the set of layers is further partitioned to multiple layer groups, each layer group comprising one or more layers, and wherein one or more of:
each layer in a same layer group is associated a same subset of the plurality of CSI-RS ports;
at least two different layer groups are associated with mutually exclusive subsets of the plurality of CSI-RS ports; or
a number of groups of the multiple layer groups is based on a value of the RI.

5. The UE of claim 4, wherein a number of groups of the multiple layer groups is no less than half of the value of the RI.

6. The UE of claim 1, wherein the CQI is associated with the subband format according to a subband configuration.

7. The UE of claim 6, wherein CQI values associated with only even subbands are included in the CSI report.

8. The UE of claim 6, wherein a value of the RI is larger than four.

9. The UE of claim 8, wherein the CSI report comprises at least two values of the CQI, a first value of the at least two values of the CQI is associated with only even subbands, and a second value of the at least two values of the CQI is associated with only odd subbands.

10. The UE of claim 1, wherein the PMI is associated with the subband format.

11. The UE of claim 10, wherein the PMI comprises a plurality of PMI values associated with a plurality of PMI subbands.

12. The UE of claim 11, wherein a number of the plurality of PMI subbands is based on at least one of a subband configuration, and a configuration value of a number of PMI subbands per CQI subband.

13. The UE of claim 11, wherein PMI values associated with only even PMI subbands are included in the CSI report.

14. The UE of claim 10, wherein a value of the RI is larger than one.

15. The UE of claim 14, wherein the set of layers is partitioned into at least two subsets of layers, and PMI corresponding to a first subset of layers of the at least two subsets of layers is associated with only even subbands, and PMI corresponding to a second subset of layers of the at least two subsets of layers is associated with only odd subbands.

16. A processor for wireless communication, comprising:
at least one controller coupled with at least one memory and configured to cause the processor to:
generate a channel state information (CSI) report comprising a precoding matrix indicator (PMI) for at least one precoding matrix and a channel quality indicator (CQI) for channel quality:
the at least one precoding matrix corresponding to a set of layers with each layer of the set of layers associated with a spatial beam and a size of the set of layers determined by a rank indicator (RI) reported by a user equipment (UE);
the at least one precoding matrix being associated with a subset of CSI reference signal (RS)(CSI-RS) ports of a plurality of CSI-RS ports; and
the PMI and the CQI each being associated with at least one of a wideband format or a subband format, and the subband format corresponding to reporting at least one of the PMI or the CQI for a subset of a set of subbands of a bandwidth part associated with a CSI reporting setting; and
transmit the CSI report including the RI, the PMI, and the CQI to a network entity.

17. The processor of claim 16, wherein the at least one controller is configured to cause the processor to:
receive, from the network entity, a configuration signal corresponding to the CSI reporting setting;
receive CSI-RS corresponding to at least one non-zero power (NZP) CSI-RS resource comprising the plurality of CSI-RS ports and based at least in part on the CSI reporting setting; and
generate the CSI report based at least in part on the CSI reporting setting and the CSI-RS.

18. The processor of claim 16, wherein the at least one controller is configured to cause the processor to report a group of spatial beams corresponding to the set of layers, and wherein one or more of:
an association of each spatial beam of the group of spatial beams with a layer in the set of layers is indicated in the CSI report; or
a spatial beam in the group of spatial beams is associated with a subset of the set of layers, the subset of the set of layers being identified by the UE and indicated in the CSI report.

19. A method performed by a user equipment (UE), the method comprising:
generating a channel state information (CSI) report comprising a precoding matrix indicator (PMI) for at least one precoding matrix and a channel quality indicator (CQI) for channel quality:
the at least one precoding matrix corresponding to a set of layers with each layer of the set of layers associated with a spatial beam and a size of the set of layers determined by a rank indicator (RI) reported by the UE;
the at least one precoding matrix being associated with a subset of CSI reference signal (RS)(CSI-RS) ports of a plurality of CSI-RS ports; and
the PMI and the CQI each being associated with at least one of a wideband format or a subband format, and the subband format corresponding to reporting at least one of the PMI or the CQI for a subset of a set of subbands of a bandwidth part associated with a CSI reporting setting; and
transmitting the CSI report including the RI, the PMI, and the CQI to a network entity.

20. A network entity for wireless communication, comprising:
at least one memory; and
at least one processor coupled with the at least one memory and configured to cause the network entity to:
transmit, to a user equipment (UE), a configuration signal corresponding to a channel state information (CSI) reporting setting, the CSI reporting setting comprising:
an indication to generate a CSI report for at least a subset of CSI reference signal (RS)(CSI-RS) ports of a plurality of CSI-RS ports including a precoding matrix indicator (PMI) for at least one precoding matrix and a channel quality indicator (CQI) for channel quality;
the at least one precoding matrix corresponding to a set of layers with each layer of the set of layers associated with a spatial beam and a size of the set of layers determined by a rank indicator (RI) reported by the UE; and
the PMI and the CQI each being associated with at least one of a wideband format or a subband format, and the subband format corresponding to reporting at least one of the PMI or the CQI for a subset of a set of subbands of a bandwidth part associated with the CSI reporting setting; and
receive, from the UE, a CSI report including the RI, the PMI, and the CQI.
